(19) United States
(12) Patent Application Publication
(10) Pub. No.: US 2025/0307346 A1
(43) Pub. Date: Oct. 2, 2025

(54) ARITHMETIC UNIT AND ARITHMETIC METHOD

(71) Applicant: Fujitsu Limited, Kawasaki-shi (JP)

(72) Inventors: Hiroyuki Wada, Kawasaki (JP); Kenichi Kitamura, Kawasaki (JP)

(73) Assignee: Fujitsu Limited, Kawasaki-shi (JP)

(21) Appl. No.: 19/075,012

(22) Filed: Mar. 10, 2025

(30) Foreign Application Priority Data
Mar. 26, 2024 (JP) 2024-050438

(51) Int. Cl. G06F 17/16

(52) U.S. Cl. CPC G06F 17/16

(57) ABSTRACT

An arithmetic unit executes a DOT operation, the arithmetic unit including a processor configured to, first determine whether or not an operation of the addition result and the addend is effective subtraction or effective addition, on a basis of the elements and the addend, and perform digit alignment of the addend with respect to a subtotal of the products, second determine whether or not there is a possibility that a value to be output becomes negative, on a basis of the elements, and calculate the product subtotal based on the addition result that becomes a negative or positive value, on a basis of a predetermined bias value and the elements, and calculate an operation result by executing addition of the product subtotal calculated and the addend, on a basis of a determination result of the first determination and a determination result of the second determination.

### CROSS-REFERENCE TO RELATED APPLICATION

This application is based upon and claims the benefit of priority of the prior Japanese Patent Application No. 2024-050438, filed on Mar. 26, 2024, the entire contents of which are incorporated herein by reference.

### FIELD

The embodiment discussed herein is related to an arithmetic unit and an arithmetic method.

### BACKGROUND

With remarkable progress and spread of artificial intelligence (AI) technology in recent years, expectations for a processor to process operations suitable for AI processing at high speed and efficiently are increasing. One of such operations is a floating point DOT operation. The DOT operation is a type of inner product operation, and the feature thereof is to perform element-wise multiplication on two vectors and accumulate all the results.

Here, in the floating point operation, one of the most main operations in the related art is an operation called fused multiply add (FMA operation) in which one floating point multiplication and one floating point addition using the result are collectively performed. A conventional processor is mounted with a large number of arithmetic units called fused multiply adder (FMA) that process an FMA operation by one operation input.

Also in the floating point DOT operation, an operation result can be acquired by repeatedly using such an arithmetic unit for each element of the vector, one element at a time, and sequentially accumulating results. In addition, in an arithmetic unit of a processor suitable for AI, it has been studied to improve the efficiency of the DOT operation by performing a plurality of floating point multiplications simultaneously in one instruction execution and accumulating results at once.

For example, as a technology using the DOT operation, a technology has been proposed in which floating point (FP) 32 data is quantized to FP8, including a bias value for shifting a dynamic range, and a SIMD product-sum operation is performed by a DOT4 operation that executes a four-element DOT product in one instruction.

Patent Document 1: Japanese Laid-open Patent Publication No. 2023-000142

However, the conventional FMA arithmetic unit, which is specialized for one FMA operation, performs processing as effective addition when the sign of the product and the sign of an addend added to the result of the product are the same, and performs processing as effective subtraction when both are different. The effective addition and the effective subtraction in the floating point greatly differ in the nature of the processing. Therefore, it is desirable to determine the sign of the product at an early stage and determine, at an early stage of operation, whether the subsequent internal processing becomes effective addition or effective subtraction. On the other hand, in the case of the DOT operation, the final accumulated value is the sum of a plurality of products that can be either positive or negative, and the sign of the accumulated value is not able to be immediately determined. That is, whether to perform effective addition or effective subtraction is not determined at an early stage. Therefore, in the conventional FMA arithmetic unit, it is difficult to process batch addition in the DOT operation, and it is difficult to enhance an operation function to enable the execution of the DOT operation.

In general, in a processor, it is not sufficient to be able to perform only the DOT operation or only the FMA operation, and it is needed to be able to execute both operations. However, as described above, it is difficult to perform the batch addition of the DOT operation in the conventional FMA arithmetic unit. As a simple method for processing both the DOT operation and the FMA operation at high speed, it is conceivable to mount the respective arithmetic units independently, but a circuit area becomes large, which is not practical.

### SUMMARY

According to an aspect of an embodiment, an arithmetic unit executes a DOT operation of adding an addend to an addition result obtained by adding a plurality of products of two elements, the arithmetic unit including a processor configured to, first determine whether or not an operation of the addition result and the addend is effective subtraction or effective addition, on a basis of the elements and the addend, and perform digit alignment of the addend with respect to a subtotal of the products, second determine whether or not there is a possibility that a value to be output becomes negative, on a basis of the elements, and calculate the product subtotal based on the addition result that becomes a negative or positive value, on a basis of a predetermined bias value and the elements, and calculate an operation result by executing addition of the product subtotal calculated and the addend, on a basis of a determination result of the first determination and a determination result of the second determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an arithmetic unit according to an embodiment;

FIG. 2 is a block diagram illustrating details of a digit alignment unit;

FIG. 3 is a diagram for explaining continuity of operation results;

FIG. 4 is a diagram illustrating an operation in each case of a combination of a tentative sign and a sign (positive or negative) of a value output to a product bus;

FIG. 5 is a block diagram illustrating details of a DOT operation multiplication-addition unit;

FIG. 6 is a block diagram illustrating details of an addition unit;

FIG. 7 is a diagram for explaining determination of processing executed in a HIGH region;

FIG. 8 is a block diagram illustrating details of a normalization/rounding unit;

FIG. 9 is a diagram for explaining determination of digit gain/digit loss in the HIGH region;

FIG. 10 is a flowchart of arithmetic processing by the arithmetic unit according to the embodiment;

FIG. 11 is a flowchart illustrating details of bias and operation determination processing;

FIG. 12 is a flowchart of addition processing by the addition unit; and

FIG. 13 is a hardware configuration diagram of an information processing apparatus on which the arithmetic unit according to the embodiment is mounted.

### DESCRIPTION OF EMBODIMENT

Preferred embodiments of the present invention will be explained with reference to accompanying drawings. Note that the arithmetic unit and the arithmetic method disclosed in the present application are not limited by the following embodiment.

### Overall Configuration

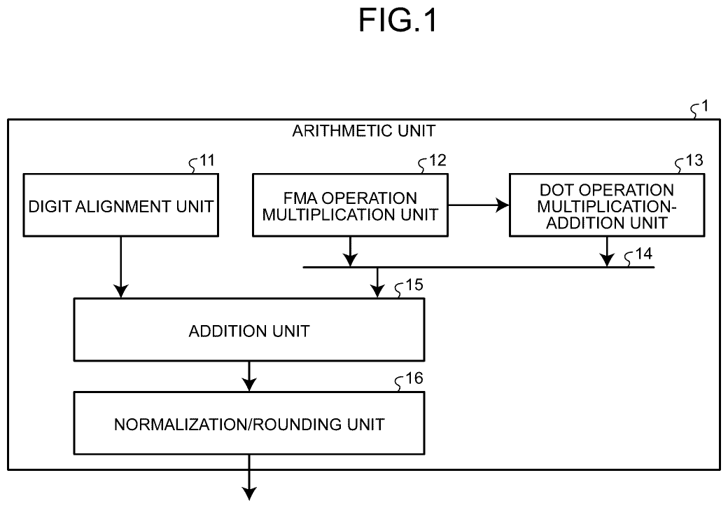

FIG. 1 is a block diagram of an arithmetic unit according to an embodiment. As illustrated in FIG. 1, the arithmetic unit 1 includes a digit alignment unit 11, an FMA operation multiplication unit 12, a DOT operation multiplication-addition unit 13, a product bus 14, an addition unit 15, and a normalization/rounding unit 16. The arithmetic unit 1 according to the present embodiment can perform both an FMA operation and a DOT operation by processing a product subtotal that is an addition result of products of elements in the DOT operation using the addition unit 15 that performs addition of the FMA operation.

In the FMA operation, an operation result is obtained from (A*B)+C. In addition, in the DOT operation, an operation result is obtained from (A1*B1)+(A2*B2)+ . . . +(An*Bn)+C. C is called an addend. Here, “*” represents multiplication, and A, A1 to An, B, and B1 to Bn are elements of two vectors to be integrated.

The product bus 14 corresponds to a portion of the FMA arithmetic unit where the absolute value of the product is output as a positive number in a Sum+Carry format by carry save addition. In the FMA operation, in a case where (A*B)+C is calculated, an operation result expressed in the Sum+Carry format of a result of a product (A*B) is output from the FMA operation multiplication unit 12 to the product bus 14. On the other hand, in the DOT operation, in a case where (A1*B1)+ . . . +(An*Bn)+C is calculated, an operation result expressed in the Sum+Carry format of the product subtotal (A1*B1)+ . . . +(An*Bn) is output from the DOT operation multiplication-addition unit 13 to the product bus 14.

Here, in the Sum+Carry format, since the carry indicated by Carry does not propagate in the Sum+Carry format, the addition can be processed with a small number of logical stages regardless of the number of digits, and the Sum+Carry format is suitable for processing of putting together many terms such as (A1*B1)+ . . . +(An*Bn) by addition. By using the number in the Sum+Carry format based on carry save addition instead of normal binary numbers, it is possible to suppress the number of times of performing delay and large “carry propagation addition” of the circuit.

In the FMA operation, A, B, and C are often

expressions with the same accuracy. However, in the DOT operation, a high-accuracy format is often used for C as compared with A and B due to the property of adding products. That is, it is general to perform processing of obtaining a large number of multiplication results between numbers having a small number of digits and adding the multiplication results at once to a variable having a large number of digits. That is, the number of digits and properties that need to be processed are different between the addition in (A1*B1)+(A2*B2)+ . . . +(An*Bn) and the final addition of+C, and the addition of+C is slightly similar to the addition of+C in the FMA operation.

In this regard, for the FMA operation multiplication unit 12 that performs the operation of (A*B) that is the multiplication of the FMA operation, in the DOT operation, another DOT operation multiplication-addition unit 13 performs calculation of (A1*B1)+(A2*B2)+ . . .+(An*Bn) that is a product subtotal. Then, in the case of processing the DOT operation, the arithmetic unit 1 allows the DOT operation multiplication-addition unit 13 to output a negative number to the product bus 14.

In the case of the FMA operation, the addition unit 15 acquires the result of the product calculated by the FMA operation multiplication unit 12 from the product bus 14. In addition, in the case of the DOT operation, the addition unit 15 acquires the product subtotal calculated by the DOT operation multiplication-addition unit 13 from the product bus 14. Then, the addition unit 15 makes the subsequent calculation of the addition of the addend common between the FMA operation and the DOT operation. FMA operation

Here, the FMA operation will be described. In the FMA operation, it is determined whether the addition unit 15 effectively performs addition or subtraction in the subsequent processing, on the basis of whether the value of the result of the product by the FMA operation multiplication unit 12 and the addend have the same sign or different signs. In the case of the FMA operation, whether the value of the result of the product and the addend have the same sign or different signs is determined at an early stage after starting the operation, so that the processing in the addition unit 15 can be performed at an early stage.

Specifically, in the FMA operation, the processing differs significantly at four points depending on whether the result of the product and the addend have different signs or the same sign. At a first point, the difference in the processing is whether or not the addend is complemented in the LOW region before performing addition with the product. In addition, at a second point, the difference in the processing is whether or not the addition result of the LOW region is sign-inverted.

In the complementing of the addend of the LOW region in the first point, one's complement is generally used. Therefore, in order to obtain a correct operation result, 1 is added to the lowest-order digit of the mantissa of the addend to be changed to two's complement. In the FMA operation, since the addition of the product and the addend is executed after the complementing of the addend, the conventional FMA arithmetic unit holds information obtained by complementing the addend and performs increment processing at the time of addition with the product to perform change to two's complement.

In addition, the processing of the FMA operation also changes depending on whether or not the addend is dominant. Here, a case where the normalization number is used as the floating-point number in the operation will be described. The description that the addend is dominant means that the highest-order digit of the mantissa of the addend is located several digits higher than the highest-order digit of the mantissa of the product.

In a case where the addend is dominant, even if the result of the product and the addend have different signs, the absolute value of the result of the product is relatively smaller than the absolute value of the addend. Therefore, the sign of the addend matches with the sign of the value obtained by adding the result of the product and the addend, and the sign of the addend becomes the sign of the operation result. On the other hand, in a case where the addend is non-dominant and the addend and the result of the product have different signs, it may be difficult to determine whether the sign of the operation result is the sign of the result of the product or the sign of the addend, and in principle, the sign of the operation result is determined after the result of the product and the addend are added. Since the procedure for obtaining the result differs, in the FMA operation, processing is generally performed by distinguishing whether or not the addend is dominant.

Here, a range of low digits from the lowest-order digit of the mantissa operation to a digit that is predetermined several digits above the highest-order digit of the mantissa of the product is referred to as a “LOW region”, and high-order digits above the LOW region are referred to as a “HIGH region”. That is, the description that the addend is dominant means that the highest-order digit of the mantissa of the addend is in the HIGH region when the mantissa of the addend is digit-aligned to the position of the mantissa of the product, and the description that the addend is not dominant means that the entire mantissa of the addend is included in the LOW region when the mantissa is aligned.

In this regard, at a third point of the difference in the processing based on whether the result of the product and the addend have different signs or the same sign, the difference is whether the operation executed in the HIGH region is processed as a decrement or processed as an increment when the addend is dominant. Furthermore, at a fourth point, the difference is that, due to a change in the number of digits that may occur in the third point, the processing in the HIGH region is performed with one digit gain or one digit loss. Here, the selection of the processing of the fourth point is used to determine the shift amount of the normalization shift of the mantissa at the time of normalization performed after addition of the addend.

### Processing in Case of FMA Operation

Based on the above points, processing of each unit in the case of the FMA operation will be described. In the FMA operation, the FMA operation multiplication unit 12 performs multiplication of the mantissa part by using the absolute values of mantissas, and the result of the product is output to the product bus 14 in a carry-save representation in the sum+carry format. The FMA operation multiplication unit 12 outputs a positive number to the product bus 14 as the result of the product since the product is a product of mantissas of the absolute value of the multiplier and the absolute value of the multiplicand.

The digit alignment unit 11 determines whether to perform effective addition or effective subtraction, based on the sign of the multiplier and the sign of the multiplicand of the FMA operation. In addition, the digit alignment unit 11 determines whether or not the addend is dominant, based on the exponent of the multiplier, which is one of the numbers to be multiplied, the exponent of the multiplicand, which is the other number, and the exponent of the addend. Furthermore, the digit alignment unit 11 shifts the mantissa of the addend in accordance with the multiplier and the multiplicand, divides the mantissa into the value in the LOW region and the value in the HIGH region, and outputs the divided values to the addition unit 15. At this time, in the case of effective subtraction, the digit alignment unit 11 converts the value in the LOW region of the mantissa of the addend into one's complement and output the result.

The addition unit 15 acquires, from the product bus 14, the result of the product represented by the carry-save representation in the sum+carry format. Next, in the LOW region, the addition unit 15 adds three numbers: two numbers of sum+carry representing the mantissa of the result of the product and the value in the LOW region of the mantissa of the addend. Here, in the case of effective subtraction in which the sign of the addend and the sign of the result of the product are different, in the addition, the addition unit 15 uses a value obtained by converting the value in the LOW region into one's complement by the digit alignment unit 11. In the following description of the FMA operation, the value in the LOW region of the mantissa of the addend or the value obtained by converting the numerical value thereof into one's complement is collectively referred to as “the value in the LOW region”. Specifically, the addition unit 15 uses a full adder to convert the three numbers of the sum, the carry, and the value in the LOW region into two numbers, and then adds the two numbers. Here, the two numbers obtained by converting the three numbers are denoted as P and Q, respectively.

When P+Q that is the addition of the two numbers is executed, the addition unit 15 converts the mantissa into absolute value representation as used by the floating-point representation format and makes the complement of the mantissa of the addend consistent. Specifically, the addition unit 15 outputs one of the following as the calculation result.

In a case where the result of the product and the addend have the same sign and are involved in effective addition, the addition unit 15 normally outputs P+Q since the processed mantissa is not complemented.

On the other hand, in a case where the result of the product and the addend have different signs and are involved in effective subtraction, if the addend is non-dominant and the operation result is 0 or positive, the sign of the operation result is correct, and the absolute value is output. However, since the processed mantissa is in one's complement, the addition unit 15 adds 1 to the lowest-order digit of the operation result to obtain a correct result in the range of the LOW region. That is, the addition unit 15 outputs P+Q+1. The processing of the addition unit 15 corresponds to an increment performed at the time of addition for the first point of the difference in the processing based on whether the result of the product and the addend have different signs or the same sign.

In addition, in a case where the result of the product and the addend have different signs and are involved in effective subtraction, if the addend are non-dominant and the operation result is negative, the addition unit 15 takes the complement of the operation result in order to convert the operation result into an absolute value. Here, what is desired to be obtained is the absolute value of the addition result of the result of the product that is a negative number and the mantissa of the processed addend, but since the mantissa of the processed addend is in one's complement, the addition result of the result of the product and the mantissa of the processed addend is also a negative number represented in one's complement. Therefore, the absolute value is obtained by inverting each bit of P+Q. That is, the addition unit 15 outputs ¬(P+Q). In this case, “¬” represents inversion of each bit.

In addition, in a case where the result of the product and the addend have different signs and are involved in effective subtraction, and the addend is dominant, the sign of the addend is the sign of the operation result. However, the mantissa of the addend processed in the operation is in one's complement, and the sign thereof is reversed from the sign of the original addend. In addition, the result of the product is calculated using normal binary numbers although the result has the opposite sign of the addend. Therefore, the addition result also has a sign opposite to the final operation result, and the mantissa is a negative number. Here, since a negative number is represented in one's complement, each bit of the operation result is inverted in order to obtain an absolute value. That is, the addition unit 15 outputs ¬(P+Q).

In summary, for the LOW region, the addition unit 15 takes P+Q as the operation result at this time point in the case of effective addition, and takes P+Q+1 or ¬(P+Q) as the operation result at this time point depending on the situation in the case of effective subtraction.

Then, in a case where the addend is non-dominant, the addition unit 15 takes the operation result of the LOW region obtained above as the operation result of the mantissa part.

On the other hand, in a case where the addend is dominant, a part of the mantissa of the addend exists in the HIGH region which is high-order digits above the LOW region. In the HIGH region, the addition unit 15 performs processing of any one of +1 (increment), −1 (decrement), and ±0 (through) on the numerical value of the HIGH region depending on whether or not carry, borrow, or neither has effectively occurred in the addition or subtraction in the LOW region.

In the case of effective addition, since the borrow does not occur, the addition unit 15 performs either +1 or ±0. In addition, in a case of effective subtraction, since the carry does not occur, thus the addition unit 15 performs either −1 or ±0. In this regard, as the processing for the mantissa of the HIGH region, processing to be executed by the addition unit 15 is determined from two options based on the determination result of the presence or absence of the carry or the borrow, excluding a case where the carry or the borrow does not occur.

Note that, due to the characteristic of the structure of the Wallace tree usually used in multiplication, when the sum and the carry are added, the product results in a value in which carry is obtained from the highest order. That is, in the case of effective addition, even if one carry occurs from the LOW region to the HIGH region, it is not true carry, and a case where the second carry occurs means that there is carry. Furthermore, in a case where the LOW region of the addend is in complement in effective subtraction, carry resulting from a value that becomes a minuend during the complementation is also considered. That is, in the case of effective subtraction, if only one carry occurs from the LOW region to the HIGH region, it indicates that there is effectively borrow, and if two carries occur, it indicates that there is effectively no borrow.

The addition unit 15 calculates a mantissa operation result by the above-described operation of the LOW region and operation of the HIGH region.

Thereafter, the normalization/rounding unit 16 performs exception processing such as normalization, rounding, overflow, or underflow on the operation result of the mantissa calculated by the addition unit 15, and calculates a final result of the FMA operation.

As described above, the FMA operation multiplication unit 12 executes multiplication of two numbers in the FMA operation of multiplying the two numbers and adding the addend, and outputs the multiplication result to the product bus 14.

### Processing in Case of DOT Operation

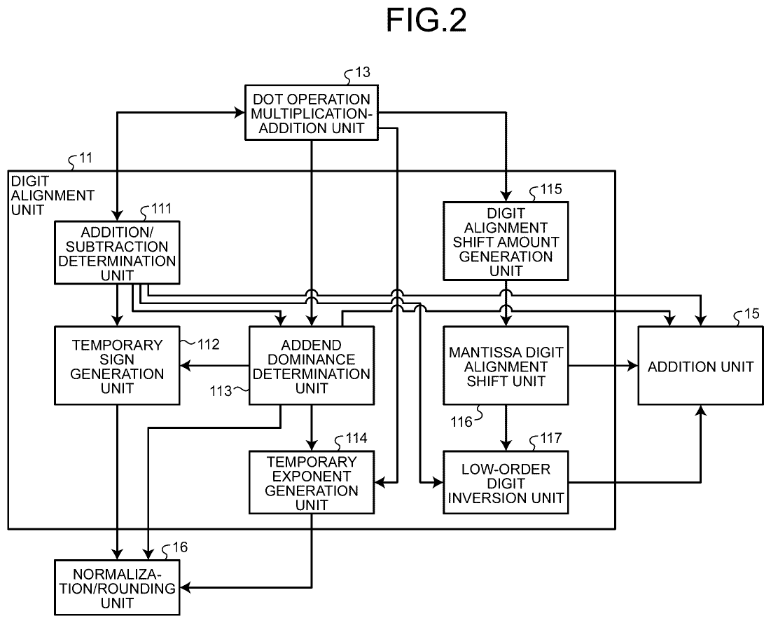

Next, processing of each unit in the case of the DOT operation will be described. The digit alignment unit 11 determines whether or not it is effective subtraction, determines whether or not the addend is dominant, and executes digit alignment of the mantissa of the addend. FIG. 2 is a block diagram illustrating details of the digit alignment unit 11. As illustrated in FIG. 2, the digit alignment unit 11 includes an addition/subtraction determination unit 111, a temporary sign generation unit 112, an addend dominance determination unit 113, a temporary exponent generation unit 114, a digit alignment shift amount generation unit 115, a mantissa digit alignment shift unit 116, and a low-order digit inversion unit 117.

The addition/subtraction determination unit 111 receives an input of a sign of an addend. In addition, the addition/subtraction determination unit 111 receives, from the DOT operation multiplication-addition unit 13, an input of a tentative sign of a product subtotal that is an addition result of products of respective elements in the DOT operation.

Then, the addition/subtraction determination unit 111 determines whether or not the tentative sign of the product subtotal matches the sign of the addend. In a case where the tentative sign of the product subtotal matches the sign of the addend, the addition/subtraction determination unit 111 determines that effective addition is assumed. On the other hand, in a case where the tentative sign of the product subtotal is different from the sign of the addend, the addition/subtraction determination unit 111 determines that effective subtraction is assumed. Thereafter, the addition/subtraction determination unit 111 outputs a determination result of effective addition or effective subtraction to the temporary sign generation unit 112, the addend dominance determination unit 113, the low-order digit inversion unit 117, the addition unit 15, and the DOT operation multiplication-addition unit 13. Hereinafter, a determination result of effective addition or effective subtraction is referred to as an “effective operation determination result”.

This effective addition determination result corresponds to an example of the “first determination”. That is, the digit alignment unit 11 first determines whether the operation of the addition result and the addend is effective subtraction or effective addition, on the basis of each element and addend used to calculate the product subtotal, and performs digit alignment of the addend on the product subtotal.

The addend dominance determination unit 113 receives an input of an exponent of the addend. In addition, the addend dominance determination unit 113 acquires a first decimal point value of the mantissa of the addend. Furthermore, the addend dominance determination unit 113 receives an input of the tentative exponent of the product subtotal from the DOT operation multiplication-addition unit 13. In addition, the addend dominance determination unit 113 receives an input of the effective operation determination result from the addition/subtraction determination unit 111. In addition, the addend dominance determination unit 113 holds in advance a determination value for determining whether or not the addend is dominant. The determination value is a value that can determine that the addend is dominant if the highest-order digit of the mantissa of the addend is higher than the highest-order digit of the tentative exponent of the product subtotal by the digit of the judgment value or more. In the present embodiment, for example, the determination value is 2.

Next, in a case where the value obtained by subtracting the tentative exponent of the product subtotal from the exponent of the addend is larger than the determination value, the addend dominance determination unit 113 determines that the addend is dominant. In addition, in a case where the value obtained by subtracting the tentative exponent of the product subtotal from the exponent of the addend is smaller than the determination value, the addend dominance determination unit 113 determines that the addend is non-dominant. In addition, in a case where the value obtained by subtracting the tentative exponent of the product subtotal from the exponent of the addend matches the determination value, the addend dominance determination unit 113 determines that the addend is dominant in a case of effective addition. On the other hand, in the case of effective subtraction, it is determined that the addend is non-dominant. Here, in a case where it is not clear whether or not the addend is dominant, the addend dominance determination unit 113 may make a determination with reference to the first decimal point value of the mantissa of the addend. Thereafter, the addend dominance determination unit 113 outputs a determination result as to whether or not the addend is dominant to the temporary sign generation unit 112, the temporary exponent generation unit 114, the DOT operation multiplication-addition unit 13, and the normalization/rounding unit 16.

The temporary sign generation unit 112 receives an input of the addend. In addition, the temporary sign generation unit 112 receives an input of the effective operation determination result from the addition/subtraction determination unit 111. In addition, the temporary sign generation unit 112 receives an input of the determination result as to whether or not the addend is dominant from the addend dominance determination unit 113. Then, the temporary sign generation unit 112 determines a temporary sign from the sign of the addend, the effective operation determination result, and the determination result as to whether or not the addend is dominant. Then, the temporary sign generation unit 112 outputs information of the determined temporary sign to the normalization/rounding unit 16.

The temporary exponent generation unit 114 receives an input of the exponent of the addend. In addition, the temporary exponent generation unit 114 receives an input of the determination result as to whether or not the addend is dominant from the addend dominance determination unit 113. Furthermore, the temporary exponent generation unit 114 receives an input of the tentative exponent of the product subtotal from the DOT operation multiplication-addition unit 13. Then, the temporary exponent generation unit 114 determines a temporary exponent from the exponent of the addend, the determination result as to whether or not the addend is dominant, and the tentative exponent of the product subtotal. Then, the temporary exponent generation unit 114 outputs information of the determined temporary exponent to the normalization/rounding unit 16.

The digit alignment shift amount generation unit 115 receives an input of the exponent of the addend. In addition, the digit alignment shift amount generation unit 115 receives an input of the tentative exponent of the product subtotal from the DOT operation multiplication-addition unit 13. Then, using the exponent of the addend and the tentative exponent of the product subtotal, the shift amount of the mantissa of the addend is calculated such that the weight of the digit of the mantissa of the addend matches the weight of the digit of the mantissa of the product subtotal. Here, the digit alignment shift amount generation unit 115 calculates the shift amount of the right shift. Then, the digit alignment shift amount generation unit 115 outputs the calculated shift amount of the mantissa of the addend to the mantissa digit alignment shift unit 116 and the normalization/rounding unit 16.

The mantissa digit alignment shift unit 116 receives an input of the mantissa of the addend. In addition, the mantissa digit alignment shift unit 116 receives an input of the shift amount of the mantissa of the addend from the digit alignment shift amount generation unit 115. Then, the mantissa digit alignment shift unit 116 shifts the mantissa of the addend input in left-alignment to the right according to the shift amount of the mantissa of the addend, and aligns the weight of the digit of the mantissa of the addend with the weight of the digit of the mantissa of the product subtotal.

Thereafter, the mantissa digit alignment shift unit 116 outputs the number in the LOW region of the mantissa of the digit-aligned addend to the low-order digit inversion unit 117. In addition, the mantissa digit alignment shift unit 116 outputs, to the addition unit 15, the number in the HIGH region of the mantissa of the digit-aligned addend and a LOW region highest-order number that is the number of the highest order in the LOW region of the mantissa of the digit-aligned addend.

The low-order digit inversion unit 117 receives an input of the effective operation determination result from the addition/subtraction determination unit 111. In addition, the low-order digit inversion unit 117 receives an input of the number in the LOW region of the mantissa of the digit-aligned addend from the mantissa digit alignment shift unit 116. Then, in the case of effective addition, the low-order digit inversion unit 117 inverts all bits of the number in the LOW region of the mantissa of the digit-aligned addend, converts the number in the LOW region of the mantissa of the addend into one's complement, and outputs the result to the addition unit 15. In addition, in the case of effective subtraction, the low-order digit inversion unit 117 outputs, to the addition unit 15, the number in the LOW region of the mantissa of the digit-aligned addend as it is.

The DOT operation multiplication-addition unit 13 calculates the product subtotal, determines a tentative sign and a tentative exponent of the product subtotal, and gives an operation instruction to the addition unit 15. The DOT operation multiplication-addition unit 13 deals with the first point of the difference in the processing based on whether the result of the product and the addend have different signs or the same sign in the FMA operation.

Here, in the case of a normal FMA operation, whether or not to complement the addend is determined on the basis of the difference between the sign of the result of the product and the sign of the addend, but the DOT operation multiplication-addition unit 13 determines whether or not to perform one's complement on the addend, on the basis of whether the sign of the tentative sign and the sign of the addend are different or the same. Since the tentative sign can be determined considerably before the timing at which the product subtotal is output to the product bus 14, it is possible to prevent the determination as to whether the product subtotal and the addend have the different signs or the same sign from affecting the delay of the entire DOT operation. For example, in a case where the addition of two products is performed by the DOT operation, the DOT operation multiplication-addition unit 13 can determine the sign of the product subtotal at an early time point of the DOT operation by adopting, as the tentative sign, the sign of the product having a larger exponent sum among the two products.

In the case of processing the DOT operation, the arithmetic unit 1 allows the DOT operation multiplication-addition unit 13 to output a negative number to the product bus 14. Here, the sign (positive or negative) of the value of the product subtotal by (A1*B1)+ . . . +(An*Bn) output to the product bus 14 is unclear at that stage. In general, for binary representation of a number including a negative number, two's complement, one's complement, absolute value representation, and the like are used, but all are representations on the premise that the sign (positive or negative) are determined, and are not suitable for representation in the Sum+Carry format in which the sign (positive or negative) is unclear. In this regard, in the output to the product bus 14, the DOT operation multiplication-addition unit 13 according to the present embodiment uses a representation which is converted into a positive number by adding a constant that can be represented in the Sum+Carry format even if the sign (positive or negative) is unclear. Here, this constant is referred to as “bias”. The bias is removed in a later process.

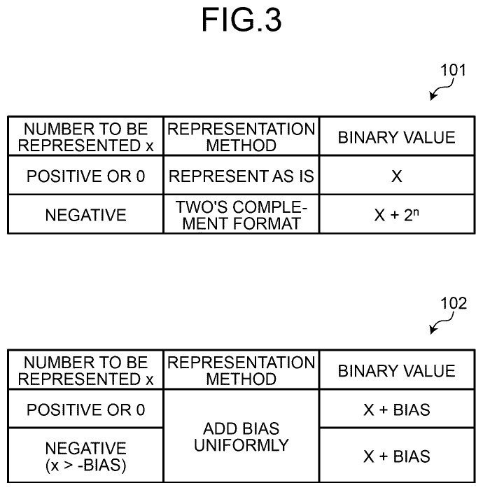

Therefore, the DOT operation multiplication-addition unit 13 outputs, as the product subtotal, the number obtained by adding, to the true operation result, a bias that is a predetermined constant regardless of the sign (positive or negative), to the product bus 14. FIG. 3 is a diagram for explaining continuity of operation results. Table 101 illustrates a representation of the number in a case where a negative number is represented in two's complement. In addition, Table 102 also illustrates the representation of the number with a bias.

In a case where a negative number is represented in two's complement, if the number to be represented is x, the binary value corresponding to x is represented as X when the number is 0 or more, and the value is represented as X+2\hat{ }n when the number is −1 or less. As described above, when a negative number is represented in two's complement, the representation is discontinuous between 0 and −1. On the other hand, in a case where the bias is added and represented, if the number to be represented is x, the value of the binary number is represented as X+bias when the number is 0 or more, and if the absolute value of x is smaller than the bias value, the value of the binary number is represented as X+bias even when the number is −1 or less. Therefore, when represented by adding the bias, the representation is continuous even between 0 and −1.

In this regard, the DOT operation multiplication-addition unit 13 uses, as the bias, a value larger than the maximum number of absolute values of negative numbers that can be taken by the true operation result, thereby making the numbers output to the product bus 14 positive and making the numbers output to the product bus 14 continuous if the true operation result is continuous. As described above, in a case where the result obtained by adding the addition result to the addend can be a negative number, the DOT operation multiplication-addition unit 13 uses, as the bias value, a value which allows the value obtained by adding the product subtotal and the addend to be positive, and corrects the addition result on the basis of the bias value to obtain the product subtotal.

As described above, by making all numbers in a range to be handled continuous in representation, it is possible to avoid switching of the representation format based on boundary determination. In addition, the DOT operation multiplication-addition unit 13 can improve compatibility with two's complement representation and one's complement representation used in other parts of the DOT operation by using, as the bias value, a power of two or a power of two minus one.

However, it is needed to eliminate the bias at some point in the DOT operation. In this regard, the DOT operation multiplication-addition unit 13 determines the bias value such that the bias value can be eliminated at the time of determination of carry or borrow from the LOW region to the HIGH region. That is, the DOT operation multiplication-addition unit 13 selects, as the bias value, a power of two (hereinafter, expressed as “2\hat{ }k”) or a number one less than the power (“(2\hat{ }k)−1”) such that the lowest-order digit in the HIGH region is set to 1.

Then, the DOT operation multiplication-addition unit 13 outputs the operation result with the bias to the product bus 14.

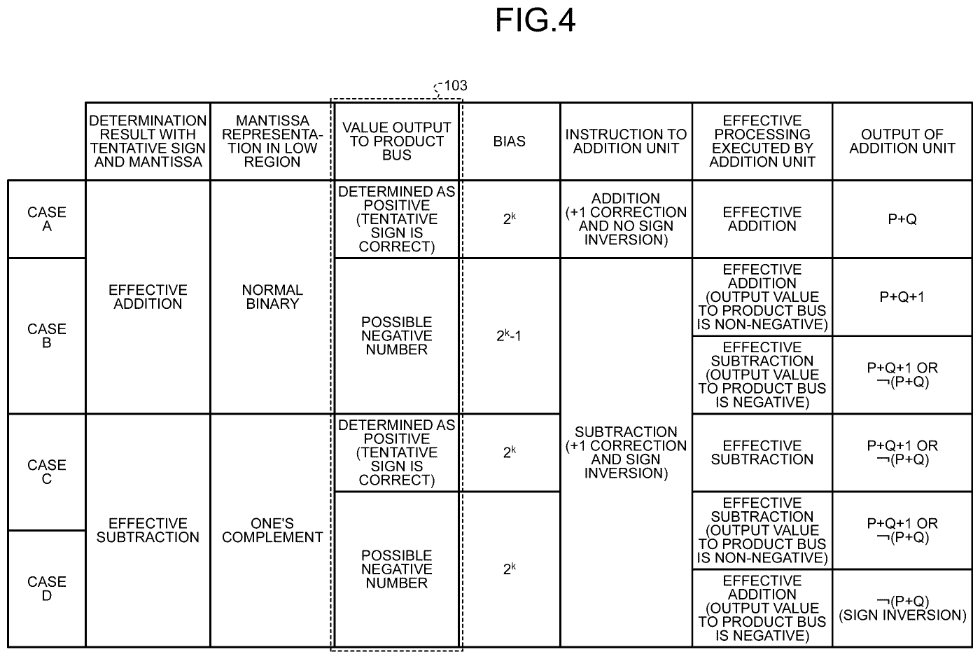

Here, in a case where the tentative sign output from the DOT operation multiplication-addition unit 13 is incorrect, a negative number is output to the product bus 14. Based on the tentative sign, there are four cases for the output of the addition unit 15 in combination with either addition or subtraction. FIG. 4 is a diagram illustrating an operation in each case of combinations of a tentative sign and the sign (positive or negative) of the value output to the product bus 14. Here, the four cases will be described as cases A to D, respectively. The four cases are classified according to the value output to the product bus 14 illustrated in an item 103 and whether the operation is effective addition or effective subtraction.

The case A is a case where effective addition is assumed since, based on the tentative sign, the addend and the value output to the product bus 14 have the same sign, and a positive number is output to the product bus 14 as predicted. In this case, it is determined that a positive number is output.

The case B is a case where effective addition is assumed since, based on the tentative sign, the addend and the value output to the product bus 14 have the same sign, but unlike prediction, there is a possibility that a negative number is output to the product bus 14. In this case, whether a positive number or a negative number is actually output is not determined.

The case C is a case where effective subtraction is assumed since, based on the tentative sign, the addend and the value output to the product bus 14 have different signs, and a positive number is output to the product bus 14 as predicted. In this case, it is determined that a positive number is output.

The case D is a case where effective subtraction is assumed since, based on the tentative sign, the addend and the value output to the product bus 14 have different signs, but unlike prediction, there is a possibility that a negative number is output to the product bus 14. Also in this case, whether a positive number or a negative number is actually output is not determined.

In the case A and the case B, the DOT operation multiplication-addition unit 13 calculates a value to be output to the product bus 14 on the assumption of effective addition in both cases, but there is a case where effective subtraction is actually performed. In the case of effective subtraction, it is preferable to set the bias value to be used to differ by one.

In the case A, the effective addition is determined, and thus the DOT operation multiplication-addition unit 13 outputs, to the product bus 14, the number obtained by adding 2\hat{ }k as the bias.

On the other hand, in the case B, effective addition is assumed based on the tentative sign, and thus the processed mantissa is not represented in one's complement. It is a normal binary positive number. Here, when a negative number to which a bias of 2\hat{ }k has been added is output to the product bus 14, a value larger by one than the correct calculation result is output as the addition result of the processed mantissa and the value of the product bus 14. In this regard, in order to avoid outputting the value larger by one than the correct calculation result, the DOT operation multiplication-addition unit 13 preferably outputs, to the product bus 14, the number obtained by using 2\hat{ }k−1 as the bias to be added to the sum of products for each element.

Here, in order to determine whether the bias is 2\hat{ }k or 2\hat{ }k−1, carry processing can be used to distinguish the sign (positive or negative), but the processing results in increase in both delay and circuit. Therefore, it is not practical to change whether or not to reduce, by one, the bias value to be added to the number to be output to the product bus 14 after determining the sign (positive or negative). If a case to be selected is determined in advance by rough determination without accurately determining the sign (positive or negative), the delay can be reduced.

In addition, in the case A among the case A and the case B, it is difficult to cope with a negative number, and thus if there is a possibility that a negative number is output to the product bus 14, it is preferable to perform processing as the case B. That is, in the case B, even if the value output to the product bus 14 is actually positive, the DOT operation multiplication-addition unit 13 uses 2\hat{ }k−1 as the bias and instructs the addition unit 15 to perform effective subtraction. That is, in a case where the DOT operation multiplication-addition unit 13 issues an instruction of effective subtraction in the addition part even though one's complement of the processed mantissa has not been performed, 2\hat{ }k−1 is set as the bias to be added to the sum of products for respective elements, and the resultant is output to the product bus 14. As a result, the addition part becomes positive due to positive+positive, and thus the calculation in the addition unit 15 can be consistent.

As described above, the DOT operation multiplication-addition unit 13 performs determination between the case A and the case B in order to determine the bias. In this regard, a boundary condition between case A and case B will be described. However, in the present embodiment, it is sufficient that, under the boundary condition between the case A and the case B, the case B is determined in all cases where “a negative number is output to the product bus 14”, and the method of calculating the boundary condition is not limited to the following method.

For example, a case where the DOT operation to be handled is (A1*B1)+(A1*B1)+C will be described. In this case, when the product of the sign of A1 and the sign of B1 and the product of the sign of A2 and the sign of B2 are different and the absolute value of the difference between the sum of the exponent of A1 and the exponent of B1 and the sum of the exponent of A2 and the exponent of B2 is two or less, the DOT operation multiplication-addition unit 13 determines the case as the case B or D. This means that it is determined that (A1*B1)+(A2*B2) is effective subtraction, and the absolute values of (A1*B1) and (A2*B2) are close, so that it is uncertain whether (A1*B1)+(A2*B2) is positive or negative.

On the other hand, in the case C, the effective subtraction is determined, and thus the DOT operation multiplication-addition unit 13 outputs, to the product bus 14, the number obtained by adding 2\hat{ }k as the bias.

In this regard, the case D is considered similar to the case B. However, in the case D, the addend is already represented in one's complement, and thus the DOT operation multiplication-addition unit 13 sets the bias value of the negative number to be output to the product bus 14 to 2\hat{ }k instead of 2\hat{ }k−1. That is, the bias value of the number to be output to the product bus 14 is different between the case B and the case D.

That is, in both the cases C and D where effective subtraction is assumed based on the tentative sign, the DOT operation multiplication-addition unit 13 outputs, to the product bus 14, the number obtained by adding 2\hat{ }k as the bias. The DOT operation multiplication-addition unit 13 may not execute to classify the case of the number to be output to the product bus 14 in both the case C and the case D, when the DOT operation multiplication-addition unit 13 determines that effective subtraction is assumed since, based on the tentative sign, the addend and the value to be output to the product bus 14 have different signs.

The DOT operation multiplication-addition unit 13 outputs the product subtotal to the product bus 14. This product subtotal also includes a case of a negative value. In addition, the DOT operation multiplication-addition unit 13 outputs the determination result as to whether it is the case A or C or the case B or D. Furthermore, in the case A, the DOT operation multiplication-addition unit 13 instructs the addition unit 15 to perform addition. In addition, in a case other than the case A, the DOT operation multiplication-addition unit 13 instructs the addition unit 15 to perform subtraction.

The determination as to whether it is the case A or C or the case B or D corresponds to an example of “a second determination as to whether or not there is a possibility that the output value becomes negative”. That is, the DOT operation multiplication-addition unit 13 second determines whether or not there is a possibility that the value to be output becomes negative on the basis of the element, and calculates a product subtotal based on an addition result that becomes a negative or positive value on the basis of a predetermined bias value and the element. More specifically, except a case where the result of the first determination indicates effective addition and the result of the second determination indicates that there is no possibility that the value to be output becomes negative, the DOT operation multiplication-addition unit 13 adds the bias value to the addition result to calculate the product subtotal. In addition, in a case where the result of the first determination indicates effective addition and the result of the second determination indicates that there is no possibility that the value to be output becomes negative, the DOT operation multiplication-addition unit 13 adds the value obtained by subtracting one from the bias value to the addition result to calculate the product subtotal. In addition, in a case where the result of the first determination indicates effective addition and the result of the second determination indicates that there is no possibility that the value to be output becomes negative, the DOT operation multiplication-addition unit 13 instructs the addition unit 15 to execute addition. In addition, in a case where the result of the first determination indicates effective subtraction or the result of the second determination indicates that there is a possibility that the value to be output becomes negative, the DOT operation multiplication-addition unit 13 instructs the addition unit 15 to execute subtraction.

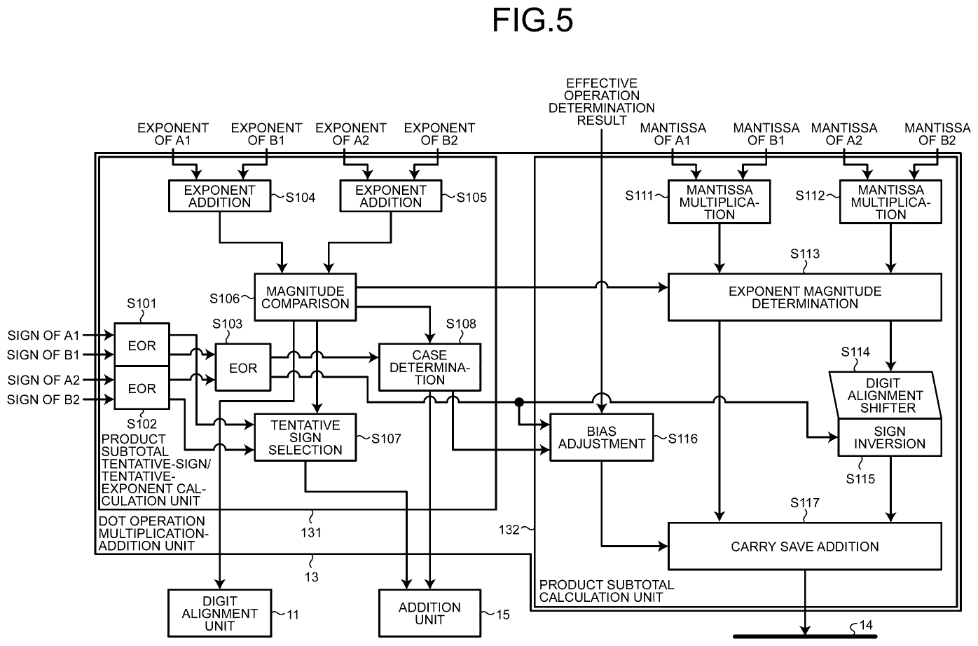

FIG. 5 is a block diagram illustrating details of the DOT operation multiplication-addition unit. Here, a specific operation of the DOT operation multiplication-addition unit 13 will be described using the DOT operation as an operation for obtaining a result of (A1*B1)+(A2*B2)+C. As illustrated in FIG. 5, the DOT operation multiplication-addition unit 13 includes a product subtotal tentative-sign/tentative-exponent calculation unit 131 and a product subtotal calculation unit 132.

The product subtotal tentative-sign/tentative-exponent calculation unit 131 receives inputs of the sign of A1 and the sign of B1, and the sign of A2 and the sign of B2. Then, the product subtotal tentative-sign/tentative-exponent calculation unit 131 calculates the exclusive OR (EOR) of the sign of A1 and the sign of B1 and the exclusive OR of the sign of A1 and the sign of B1 (steps S101 and S102). As a result, the product subtotal tentative-sign/tentative-exponent calculation unit 131 obtains the sign of each product of A1*B1 and A2*B2.

In addition, the product subtotal tentative-sign/tentative-exponent calculation unit 131 determines whether (A1*B1)+(A2*B2) is assumed as effective addition or effective subtraction by obtaining an exclusive OR of the signs of the products of A1*B1 and A2*B2 (step S103). The product subtotal tentative-sign/tentative-exponent calculation unit 131 notifies the product subtotal calculation unit 132 of the determination result of subtraction or addition.

Next, the product subtotal tentative-sign/tentative-exponent calculation unit 131 receives inputs of the exponent of A1 and the exponent of B1, and the exponent of A2 and the exponent of B2. Then, the product subtotal tentative-sign/tentative-exponent calculation unit 131 adds the exponent of A1 and the exponent of B1, and adds the exponent of A2 and the exponent of B2 to obtain the exponents of (A1*B1) and (A2*B2) (steps S104 and S105).

Next, the product subtotal tentative-sign/tentative-exponent calculation unit 131 compares the magnitudes of the exponent of (A1*B1) and the exponent of (A2*B2), and notifies the digit alignment unit 11 of the larger exponent as the exponent of the entire (A1*B1)+(A2*B2) (step S106). In addition, the product subtotal tentative-sign/tentative-exponent calculation unit 131 notifies the product subtotal calculation unit 132 of the magnitude comparison result.

In addition, the product subtotal tentative-sign/tentative-exponent calculation unit 131 selects which one between the sign of (A1*B1) or the sign of (A2*B2) to be set as the tentative sign, by using the magnitude comparison result, and notifies the addition unit 15 of the selected tentative sign (step S107).

In addition, the product subtotal tentative-sign/tentative-exponent calculation unit 131 distinguishes between the case A or C and the case B or D by using the magnitude comparison result of the exponents and the determination result as to whether (A1*B1)+(A2*B2) is assumed as effective addition or effective subtraction (step S108).

Specifically, in a case where the exponent difference between (A1*B1) and (A2*B2) is 3 or more, the product subtotal tentative-sign/tentative-exponent calculation unit 131 determines that the absolute value of the element product of the larger side is sufficiently large, the tentative sign is correct, and a positive value is output to the product bus 14. In this case, the product subtotal tentative-sign/tentative-exponent calculation unit 131 performs processing as the case A or C. That is, the product subtotal tentative-sign/tentative-exponent calculation unit 131 notifies the product subtotal calculation unit 132 of an instruction to set the bias value to 2\hat{ }k. Furthermore, the product subtotal tentative-sign/tentative-exponent calculation unit 131 instructs the addition unit 15 to perform the effective addition operation in the case A, and instructs the addition unit 15 to perform the effective subtraction operation in the case C.

In addition, even in a case where the signs of (A1*B1) and (A2*B2) are the same, the product subtotal tentative-sign/tentative-exponent calculation unit 131 performs processing as the case A or C since the signs match the tentative sign. That is, with the bias value set to 2\hat{ }k, the product subtotal tentative-sign/tentative-exponent calculation unit 131 instructs the addition unit 15 to perform the effective addition operation in the case A, and instructs the addition unit 15 to perform the effective subtraction operation in the case C.

On the other hand, in a case where the signs of (A1*B1) and (A2*B2) are different from each other and the exponential difference is 2 or less, large digit loss may occur in the subtraction of (A1*B1) and (A2*B2). In this regard, in this case, the product subtotal tentative-sign/tentative-exponent calculation unit 131 determines that the prediction of the tentative sign may be incorrect, that is, a negative value may appear in the product bus 14, and performs processing as the case B or D in accordance with the difference between the addend and the tentative sign. In the case of processing as the case B, the product subtotal tentative-sign/tentative-exponent calculation unit 131 notifies the product subtotal calculation unit 132 of an instruction to set the bias value to 2\hat{ }k−1, and instructs the addition unit 15 to perform effective subtraction. On the other hand, in the case of processing as the case D, the product subtotal tentative-sign/tentative-exponent calculation unit 131 notifies the product subtotal calculation unit 132 of an instruction to set the bias value to 2\hat{ }k, and instructs the addition unit 15 to perform effective subtraction.

The product subtotal calculation unit 132 receives inputs of the mantissa of A1 and the mantissa of B1, and the mantissa of A2 and the mantissa of B2. Then, the product subtotal calculation unit 132 calculates (mantissa of A1*mantissa of B1 mantissa) and (mantissa of A2*mantissa of B2) (steps S111 and S112).

Next, the product subtotal calculation unit 132 determines the magnitudes of the exponents of (mantissa of A1*mantissa of B1) and (mantissa of A2*mantissa of B2) on the basis of the magnitude comparison result of the exponents of (A1*B1) and (A2*B2) notified by the product subtotal tentative-sign/tentative-exponent calculation unit 131 (step S113).

Then, the product subtotal calculation unit 132 executes a digit alignment shifter on the product with the smaller exponent of (mantissa of A1*mantissa of B1) or (mantissa of A2*mantissa of B2). Furthermore, the product subtotal calculation unit 132 performs sign inversion in accordance with the determination result, which is notified by the product subtotal tentative-sign/tentative-exponent calculation unit 131, as to whether (A1*B1)+(A2*B2) is assumed as addition or subtraction (steps S114 and S115).

In addition, the product subtotal calculation unit 132 adjusts the bias by using the effective operation determination result performed by the digit alignment unit 11, the case determination result, and the determination as to whether (A1*B1)+(A2*B2) is assumed as effective addition or effective subtraction (step S116).

Thereafter, the product subtotal calculation unit 132 executes carry save addition of (mantissa of A1*mantissa of B1) and (mantissa of A2*mantissa of B2) to which the bias value is added (step S117). Then, the product subtotal calculation unit 132 outputs carry and sum of the product subtotal, which is the operation result, to the product bus 14.

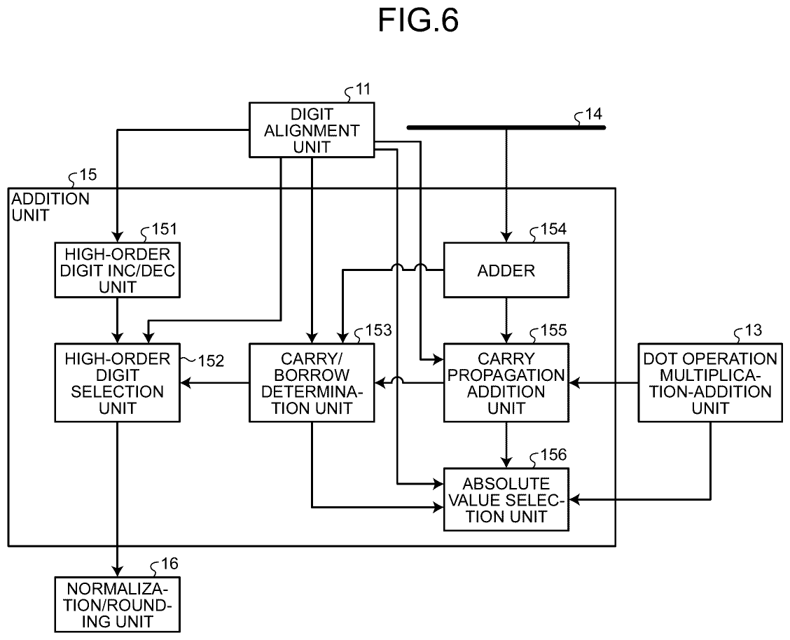

FIG. 6 is a block diagram illustrating details of the addition unit. Next, the addition unit 15 will be described with reference to FIG. 6. The addition unit 15 deals with the second point of the difference based on whether the product and the addend have different signs or the same sign in the FMA operation. As illustrated in FIG. 6, the addition unit 15 includes a high-order digit INC/DEC unit 151, a high-order digit selection unit 152, a carry/borrow determination unit 153, an adder 154, a carry propagation addition unit 155, and an absolute value selection unit 156.

The high-order digit INC/DEC unit 151 determines whether to increment or decrement in the HIGH region. That is, the high-order digit INC/DEC unit 151 deals with the third point of the difference in the processing based on whether the result of the product and the addend have different signs or the same sign in the FMA operation.

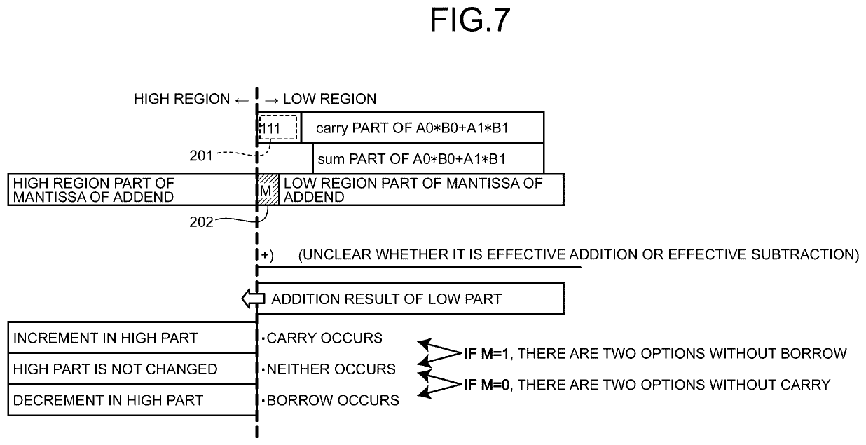

The high-order digit INC/DEC unit 151 receives, from the digit alignment unit 11, inputs of the value in the HIGH region of the mantissa of the addend and the LOW region highest-order number of the mantissa of the addend after the digit alignment is performed. FIG. 7 is a diagram for explaining determination of processing executed in the HIGH region. A numerical value 201 in FIG. 7 corresponds to the bias.

The high-order digit INC/DEC unit 151 acquires, from the digit alignment unit 11, the number at a highest-order digit 202 in the LOW region of the addend after the digit alignment of the addend, as the LOW region highest-order number. Here, if the value of the highest-order digit 202 is 0, even if carry occurs anywhere in the LOW region, the propagation of the effective carry stops at the LOW region highest-order digit, and thus the increment in the HIGH region does not occur. On the other hand, since there is a case where the propagation of borrow does not stop at the highest order, a decrement in the HIGH region may occur. On the other hand, if the value of the highest-order digit 202 is 1, even if borrow occurs anywhere in the LOW region, the propagation of the effective borrow stops at the LOW region highest-order digit, and thus the decrement in the HIGH region is not able to occur. On the other hand, since there is a case where the propagation of carry does not stop at the highest order, an increment in the HIGH region may occur.

That is, assuming that the value of the highest-order digit 202 is M, the high-order digit INC/DEC unit 151 acquires the value of the highest-order digit 202 as the LOW region highest-order number, and if M=0, the HIGH region has two options of −1 or ±0. Then, the high-order digit INC/DEC unit 151 outputs, to the high-order digit selection unit 152, a value obtained by decrementing, by one, the value in the HIGH region of the mantissa of the addend and the value in the HIGH region of the mantissa of the addend.

In addition, if M=1, the high-order digit INC/DEC unit 151 has two options of +1 or ±0. Then, the high-order digit INC/DEC unit 151 outputs, to the high-order digit selection unit 152, a value obtained by incrementing, by one, the value in the HIGH region of the mantissa of the addend and the value in the HIGH region of the mantissa of the addend.

As described above, the high-order digit INC/DEC unit 151 of the addition unit 15 determines whether or not an increment or a decrement occurs in a value of a high-order digit, which is predetermined digits above the highest-order digit of the product subtotal, in the addend, based on the highest-order number of the low-order digits that are below the high-order digit in the addend.

Returning to FIG. 6, the description will be continued. The carry/borrow determination unit 153 receives, from the digit alignment unit 11, inputs of the determination result as to whether or not the addend is dominant and the determination result of effective subtraction or effective addition. In addition, in a case where an overflow occurs in the addition of the addend and the product subtotal, the carry/borrow determination unit 153 receives the notification from the adder 154. In addition, in a case where an overflow occurs in the carry propagation addition, the carry/borrow determination unit 153 receives the notification from the carry propagation addition unit 155.

Then, the carry/borrow determination unit 153 determines whether the effective addition is assumed or whether the addend is dominant. In a case where the effective addition is assumed or the addend is dominant, if one overflow occurs, the carry/borrow determination unit 153 determines that neither carry nor borrow occurs. On the other hand, in a case other than a case where one overflow occurs, it is determined that either carry or borrow occurs.

On the other hand, in a case where the effective subtraction is assumed and the addend is not dominant, if two overflows occur, the carry/borrow determination unit 153 determines that neither carry nor borrow occurs. On the other hand, when two overflows do not occur, it is determined that carry occurs.

Thereafter, the carry/borrow determination unit 153 outputs the carry/borrow determination result to the high-order digit selection unit 152.

The high-order digit selection unit 152 receives an input of the information of the value in the HIGH region from the high-order digit INC/DEC unit 151. The information of the value in the HIGH region is a value in the HIGH region of the mantissa of the addend and a value obtained by decrementing, by one, the value in the HIGH region of the mantissa of the addend, or the value in the HIGH region of the mantissa of the addend and a value obtained by incrementing, by one, the value in the HIGH region of the mantissa of the addend. In addition, the high-order digit selection unit 152 receives an input of the carry/borrow determination result from the carry/borrow determination unit 153.

Then, in a case where there is either carry or borrow, the high-order digit selection unit 152 outputs, to the normalization/rounding unit 16, the value obtained by decrementing, by one, the value in the HIGH region of the mantissa of the addend or the value obtained by incrementing, by one, the value in the HIGH region of the mantissa of the addend. On the other hand, in a case where there is no carry or borrow, the high-order digit selection unit 152 outputs the value in the HIGH region of the mantissa of the addend to the normalization/rounding unit 16.

The adder 154 receives, from the low-order digit inversion unit 117 of the digit alignment unit 11, inputs of a number in the LOW region of the mantissa of the digit-aligned addend or a number obtained by converting the number in the LOW region of the mantissa of the digit-aligned addend into one's complement. In addition, the adder 154 acquires carry and sum of the product subtotal from the product bus 14.

Then, the adder 154 uses a full adder to add three numbers of the number in the LOW region of the mantissa of the addend or the number obtained by converting the number of the LOW region into one's complement, the carry of the product subtotal, and the sum of the product subtotal, so as to reduce the three numbers into two numbers. Then, the adder 154 outputs the two numbers of the addition result to the carry propagation addition unit 155. These two numbers are P and Q. In addition, in a case where an overflow occurs due to the addition, the adder 154 outputs the occurrence of the overflow to the carry/borrow determination unit 153.

The carry propagation addition unit 155 receives, from the adder 154, inputs of the two numbers which are the addition result. In addition, the carry propagation addition unit 155 receives an input of the effective operation determination result from the addition/subtraction determination unit 111 of the digit alignment unit 11. Furthermore, the carry propagation addition unit 155 receives an input of the determination result as to whether it is the case A or C or the case B or D from the product subtotal tentative-sign/tentative-exponent calculation unit 122 of the DOT operation multiplication-addition unit 13.

Here, in each of the cases A to D, it is needed that the output of the addition result from the addition unit 15 is the value illustrated in FIG. 4. In this regard, the output of the addition unit 15 for each case will be described.

In the case A, the effective addition is assumed based on the tentative sign, and the effective addition is actually performed. Therefore, the output of the addition unit 15 is P+Q.

In the case B, the effective addition is assumed based on the tentative sign, but the effective subtraction may be actually performed. In this regard, for the mantissa part operation result represented by the absolute value, the addition unit 15 may be needed to select either to use the addition result as it is since the addition result is positive or to use a value obtained by inverting the sign of the addition result to obtain the absolute value since the addition result is negative. In order to perform the selective operation, the addition unit 15 receives an instruction from the DOT operation multiplication-addition unit 13 as if effective subtraction is performed. Therefore, the output of the addition unit 15 is either P+Q+1 or ¬(P+Q). This is because it is assumed that one's complement is input as the processed mantissa. However, in the case B, in a case where the value output from the product bus 14 is a positive number, the addition unit 15 outputs P+Q+1 without performing sign inversion. As a result, the addition unit 15 offsets +1 caused by not performing sign inversion and an amount of the bias reduced by 1 from 2\hat{ }k by the DOT operation multiplication-addition unit 13 to make the calculation results in the LOW region consistent.

In the case C, based on the tentative sign, effective subtraction in which the processed mantissa is represented in one's complement is assumed, and the effective subtraction is actually performed. In this regard, similarly to the case of effective subtraction of the FMA operation, the output of the addition unit 15 is either P+Q+1 or ¬(P+Q) depending on whether or not the addend is dominant and whether or not the operation result is 0 or more.

In the case D, processing is started as effective subtraction assuming that the addend is a negative number and the value output from the product bus 14 is a positive number, but actually, the mantissa may be a negative number and the value output from the product bus 14 may also be a negative number. In a case where the value output from the product bus 14 is a positive number, the output of the addition unit 15 is either P+Q+1 or ¬(P+Q). In a case where the value output from the product bus 14 is a negative number, the addition unit 15 performs sign inversion and outputs ¬(P+Q).

On the other hand, in a case where the mantissa is actually a negative number and the value output from the product bus 14 is also actually a negative number, since both the addend and the value output from the product bus 14 are represented in complement as negative numbers, the addition unit 15 inverts the sign of the operation result. Since sign inversion is not performed in the addition part when effective addition is expected, effective subtraction is instructed from the DOT operation multiplication-addition unit 13 to the addition unit 15 so that the sign inversion can be performed. The output of the addition unit 15 is ¬(P+Q) of the result of inversion. If P+Q is represented in one's complement, the addition results are made consistent by inversion.

In order for the output from the addition unit 15 to be the output for each case as described above, the carry propagation addition unit 155 and the absolute value selection unit 156 perform, for example, the following operations.

The carry propagation addition unit 155 determines whether or not it is the case A, based on the effective operation determination result and the determination result as to whether it is the case A or C or the case B or D. That is, in a case where the case A or C is determined and the effective operation determination result indicates effective addition, the case A is determined.

Further, in a case where the case A is determined, the carry propagation addition unit 155 outputs P+Q as a positive addition result. In addition, in a case where a case other than the case A is determined, the carry propagation addition unit 155 outputs P+Q+1 as a positive addition result and outputs ¬(P+Q) as a negative addition result. Furthermore, in a case where an overflow occurs due to the addition, the carry propagation addition unit 155 outputs, to the carry/borrow determination unit 153, the fact that the overflow has occurred.

The absolute value selection unit 156 receives an input of the addition result from the carry propagation addition unit 155. In addition, the absolute value selection unit 156 receives an input of the determination result as to whether or not the addend is dominant from the addend dominance determination unit 113 of the digit alignment unit 11. In addition, the absolute value selection unit 156 receives an input of the effective operation determination result from the addition/subtraction determination unit 111 of the digit alignment unit 11. In addition, the absolute value selection unit 156 receives an input of the determination result as to whether it is the case A or C or the case B or D from the product subtotal tentative-sign/tentative-exponent calculation unit 122 of the DOT operation multiplication-addition unit 13. Furthermore, the absolute value selection unit 156 receives, from the carry/borrow determination unit 153, information indicating that carry or borrow has occurred.

Then, if the addend is dominant and the effective subtraction is assumed, the absolute value selection unit 156 outputs, as the calculation result of the LOW region, the negative addition result to the normalization/rounding unit 16. In addition, if the addend is dominant and the effective addition is assumed, the absolute value selection unit 156 outputs, as the calculation result of the LOW region, the positive addition result to the normalization/rounding unit 16.

On the other hand, in a case where the addend is non-dominant, the absolute value selection unit 156 determines whether or not it is the case A, based on the effective operation determination result and the determination result as to whether it is the case A or C or the case B or D. In the case A, the absolute value selection unit 156 outputs, as the calculation result of the LOW region, the negative addition result to the normalization/rounding unit 16 if carry or borrow has occurred. On the other hand, if carry or borrow does not occur, the absolute value selection unit 156 outputs, as the calculation result of the LOW region, the positive addition result to the normalization/rounding unit 16. In addition, in a case other than the case A, the absolute value selection unit 156 outputs, as the calculation result of the LOW region, the positive addition result to the normalization/rounding unit 16.

Furthermore, the absolute value selection unit 156 outputs, to the normalization/rounding unit 16, information indicating whether or not the negative addition result has been output.

As described above, on the basis of the determination result of the first determination and the determination result of the second determination, the addition unit 15 executes addition of the product subtotal calculated by the DOT operation multiplication-addition unit 13 and the addend to calculate the operation result. In addition, regarding the selective execution of the FMA operation and the DOT operation, the addition unit 15 acquires the result of the product or the product subtotal output from the product bus 14, and executes the addition of the result of the product and the addend or the addition of the product subtotal and the addend to calculate the operation result.

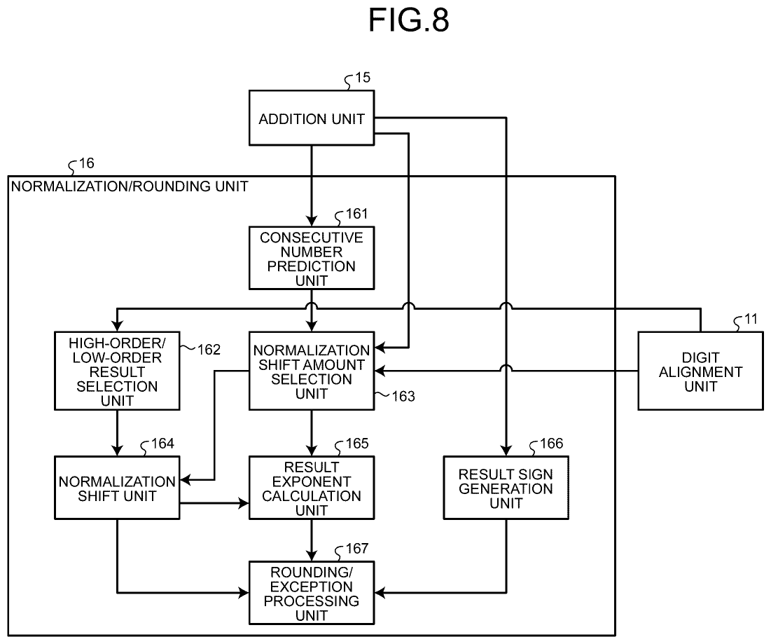

FIG. 8 is a block diagram illustrating details of the normalization/rounding unit 16. The normalization/rounding unit 16 includes a consecutive number prediction unit 161, a high-order/low-order result selection unit 162, a normalization shift amount selection unit 163, a normalization shift unit 164, a result exponent calculation unit 165, a result sign generation unit 166, and a rounding/exception processing unit 167.

The consecutive number prediction unit 161 receives an input of two numbers of the addition result from the adder 154 of the addition unit 15. Then, the consecutive number prediction unit 161 calculates, from the acquired two numbers, a prediction value of the number of consecutive 0s from the highest order and a prediction value of the number of consecutive 1s from the highest order. The consecutive number prediction unit 161 outputs, to the normalization shift amount selection unit 163, the prediction value of the number of consecutive 0s from the highest order and the prediction value of the number of consecutive 1s from the highest order.

The normalization shift amount selection unit 163 receives an input of the number at the first decimal place of the mantissa of the addend. In addition, the normalization shift amount selection unit 163 receives, from the absolute value selection unit 156 of the addition unit 15, an input of information indicating whether or not a negative addition result has been output. In addition, the normalization shift amount selection unit 163 receives an input of the shift amount of the mantissa of the addend from the digit alignment shift amount generation unit 115. In addition, the normalization shift amount selection unit 163 receives, from the consecutive number prediction unit 161, the inputs of the prediction value of the number of consecutive 0s from the highest order and the prediction value of the number of consecutive 1s from the highest order. Furthermore, the normalization shift amount selection unit 163 receives an input of the effective subtraction determination result from the addition/subtraction determination unit 111 of the digit alignment unit 11. In addition, the normalization shift amount selection unit 163 receives an input of information indicating whether or not the addend is dominant from the addend dominance determination unit 113 of the digit alignment unit 11.

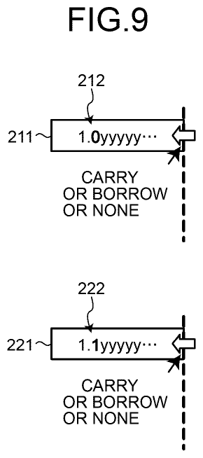

Then, the normalization shift amount selection unit 163 determines digit gain/digit loss in the HIGH region. That is, the normalization shift amount selection unit 163 deals with the fourth point of the difference based on whether the product and the addend have different signs or the same sign in the FMA operation. FIG. 9 is a diagram for explaining determination of the digit gain/digit loss in the HIGH region. Numbers 211 and 221 in FIG. 9 indicate the HIGH region part in the mantissa of the addend.

The normalization shift amount selection unit 163 refers to the second digit from the top of the mantissa of the addend. For example, the addition unit 15 refers to a digit value 212 in the case of the number 211 in FIG. 5, and refers to a digit value 222 in the case of the number 221 in FIG. 5. Here, since the addend is a normalization number, if the highest-order digit of the addend is 1 and the second digit from the top is 0 as in the digit value 212, the highest-order two digits are 10. In addition, if the second digit from the top is 1 as in the digit value 222, the highest-order two digits are 11.

If the highest-order two digits are 10, carry propagation from the lower digit stops there, and thus the highest-order digit does not carry up in the HIGH region. On the other hand, in a case where borrow has propagated, 1 of the highest-order digit becomes 0, and one digit loss may occur. If the highest-order two digits are 11, borrow propagation from the lower digit stops there, and thus digit loss does not occur. On the other hand, in a case where carry has propagated, the carry propagates to 1 of the highest-order digit, and the mantissa may increase by one digit to the higher order.

In this regard, if the digit value 212 of the second digit from the top is 0 as in the number 211, the normalization shift amount selection unit 163 can determine that the highest-order digit of the mantissa either remains unchanged or one digit loss occurs. In addition, if the digit value 222 of the second digit from the top is 1 as in the number 221, the normalization shift amount selection unit 163 can determine that the highest-order digit of the mantissa remains unchanged or one digit gain occurs.

As described above, the normalization shift amount selection unit 163 performs the determination of the processing to be executed in the HIGH region and the determination of the digit gain/digit loss independently from whether the operation of the addition result of the product and the addend is effective addition or effective subtraction. As a result, needed operation switching can be performed without increasing the delay of the entire arithmetic processing.

On the basis of the above determination, the normalization shift amount selection unit 163 obtains a normalization shift amount specifically as follows. In a case where the addend is dominant, the normalization shift amount selection unit 163 determines whether or not the second digit of the mantissa of the addend is 1. In a case where the second digit of the mantissa of the addend is 1, the normalization shift amount selection unit 163 sets, as the normalization shift amount, a value obtained by subtracting 1 from a value obtained by adding a constant to the shift amount of the mantissa of the addend. On the other hand, in a case where the second digit of the mantissa of the addend is 1, the normalization shift amount selection unit 163 sets, as the normalization shift amount, the value obtained by adding the constant to the shift amount of the mantissa of the addend. Note that the normalization shift amount selection unit 163 can use, for example, 0 as the constant.

On the other hand, in a case where the addend is dominant, the normalization shift amount selection unit 163 determines whether or not the negative addition result has been selected. In a case where the negative addition result has been selected, the normalization shift amount selection unit 163 sets the normalization shift amount as the prediction value of the number of consecutive 1s from the highest order. On the other hand, in a case where the positive addition result has been selected, the normalization shift amount selection unit 163 sets the normalization shift amount as the prediction value of the number of consecutive 0s from the highest order. The normalization shift amount is an amount of left shift.

Thereafter, the normalization shift amount selection unit 163 outputs the calculated normalization shift amount to the normalization shift unit 164 and the result exponent calculation unit 165.

The high-order/low-order result selection unit 162 receives an input of information indicating whether or not the addend is dominant from the addend dominance determination unit 113 of the digit alignment unit 11. In addition, the high-order/low-order result selection unit 162 receives an input of the value in the HIGH region of the mantissa of the addend from the high-order digit selection unit 152. In addition, the high-order/low-order result selection unit 162 receives an input of the calculation result of the LOW region from the absolute value selection unit 156.

In a case where the addend is dominant, the high-order/low-order result selection unit 162 concatenates the upper half value of the calculation result of the LOW region to the value in the HIGH region of the mantissa of the addend, and outputs, to the normalization shift unit 164, the value of the calculation result of the LOW region as the calculation result of the mantissa obtained by adding the mantissa of the product subtotal and the mantissa of the addend. On the other hand, in a case where the addend is non-dominant, the high-order/low-order result selection unit 162 outputs, to the normalization shift unit 164, the value of the calculation result of the LOW region as the calculation result of the mantissa.

The normalization shift unit 164 receives an input of the normalization shift amount from the normalization shift amount selection unit 163. In addition, the normalization shift unit 164 receives an input of the calculation result of the mantissa from the high-order/low-order result selection unit 162.

Then, the normalization shift unit 164 shifts the value of the calculation result of the mantissa to the left according to the specified normalization shift amount. Furthermore, if 0 is at the head after shifting the calculation result of the mantissa, the normalization shift unit 164 performs adjustment to shift to the left by one-digit shift adjustment. Then, the normalization shift unit 164 notifies the result exponent calculation unit 165 of whether or not the one-digit shift adjustment has been performed. In addition, the normalization shift unit 164 outputs the shifted calculation result of the mantissa to the rounding/exception processing unit 167.

The result exponent calculation unit 165 receives an input of the temporary exponent from the temporary exponent generation unit 114 of the digit alignment unit 11. In addition, the result exponent calculation unit 165 receives an input of the normalization shift amount from the normalization shift amount selection unit 163. Furthermore, the result exponent calculation unit 165 receives, from the normalization shift unit 164, the notification indicating whether or not the one-digit shift adjustment has been performed. Then, the result exponent calculation unit 165 calculates the exponent of the operation result from the temporary exponent and the normalization shift amount. Here, in a case where the one-digit shift adjustment is performed, the result exponent calculation unit 165 subtracts 1 from the calculated exponent. Thereafter, the result exponent calculation unit 165 outputs the calculated exponent to the rounding/exception processing unit 167.

The result sign generation unit 166 receives an input of the temporary sign from the temporary sign generation unit 112 of the digit alignment unit 11. In addition, the result sign generation unit 166 receives, from the absolute value selection unit 156 of the addition unit 15, an input of information indicating whether or not the negative addition result is output. Then, in a case where the negative addition result is output, the result sign generation unit 166 inverts the temporary sign and determines the final sign. In addition, in a case where the positive addition result is output, the result sign generation unit 166 determines, as the final sign, the temporary sign as it is. Thereafter, the result sign generation unit 166 outputs the determined sign to the rounding/exception processing unit 167.

The rounding/exception processing unit 167 receives an input of the shifted calculation result of the mantissa from the normalization shift unit 164. In addition, the rounding/exception processing unit 167 receives an input of the exponent from the result exponent calculation unit 165. In addition, the rounding/exception processing unit 167 receives an input of the sign from the result sign generation unit 166. Next, the rounding/exception processing unit 167 combines the mantissa, the exponent, and the sign to form the operation result. Then, if the operation result is not expressed within a predetermined accuracy range, the rounding/exception processing unit 167 performs rounding or exception processing. Thereafter, the rounding/exception processing unit 167 outputs the operation result.

As described above, the normalization/rounding unit 16 determines whether or not digit gain or digit loss occurs at a high-order digit, which is predetermined digits above the highest-order digit of the product subtotal, in the operation result calculated by the addition unit 15, normalizes the operation result, and performs rounding and exception processing to calculate the final DOT operation result.

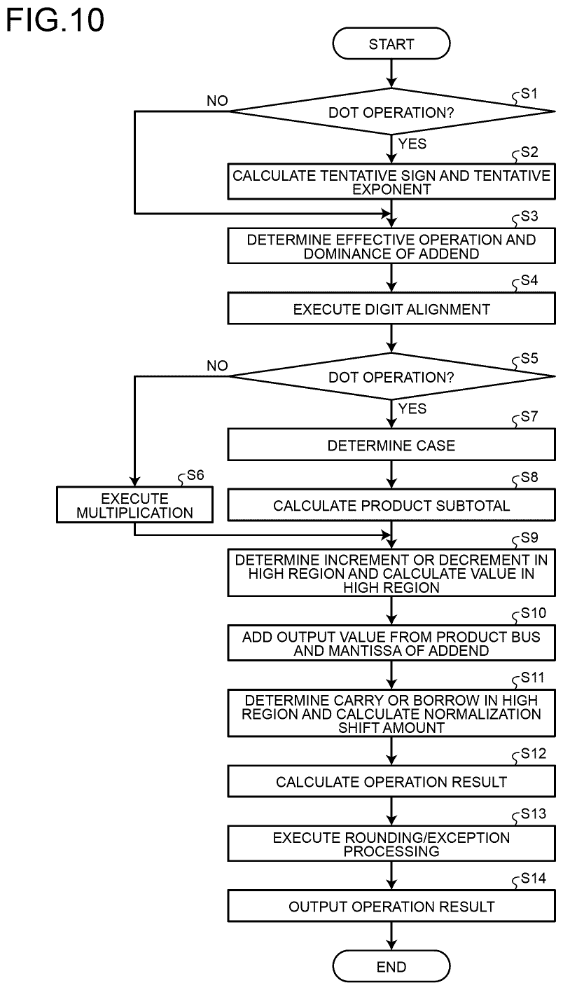

FIG. 10 is a flowchart of arithmetic processing by the arithmetic unit according to the embodiment. Next, a flow of arithmetic processing by the arithmetic unit 1 according to the embodiment will be described with reference to FIG. 10.

The FMA operation multiplication unit 12 and the DOT operation multiplication-addition unit 13 determine the FMA operation or the DOT operation, based on an input expression (step S1). In the case of not being the DOT operation (step S1: No), the arithmetic processing proceeds to step S3.

The DOT operation multiplication-addition unit 13 calculates the tentative sign and the tentative exponent of the product subtotal, based on each element used for the product of the DOT operation (step S2).

The digit alignment unit 11 uses the sign of each element in the case of the FMA operation and uses the tentative sign of the product subtotal and the sign of the addend in the case of the DOT operation, to determine whether to perform effective addition or effective subtraction, and determines the effective operation determination result. In addition, the digit alignment unit 11 uses the exponent of each element in the case of the FMA operation and uses the tentative exponent of the product subtotal and the exponent of the addend in the case of the DOT operation, to determine whether or not the addend is dominant (step S3).

Next, the digit alignment unit 11 executes digit alignment of the mantissa (step S4).

Next, the FMA operation multiplication unit 12 and the DOT operation multiplication-addition unit 13 determine the FMA operation or the DOT operation, based on an input expression (step S5). This determination can use the determination result of step S1.

In the case of the FMA operation (step S5: No), the FMA operation multiplication unit 12 executes multiplication of the mantissa of the multiplicand and the mantissa of the multiplier (step S6). The FMA operation multiplication unit 12 outputs the result of the product to the product bus 14. Thereafter, the arithmetic processing proceeds to step S9.

On the other hand, in the case of the DOT operation (step S5: Yes), the DOT operation multiplication-addition unit 13 uses the sign of each element used for the product and the boundary condition between the case A and the case B, to determine whether it is the case A or C or the case B or D (step S7).

In addition, the DOT operation multiplication-addition unit 13 determines the bias value based on whether or not it is effective subtraction, and calculates the product subtotal added with the bias value from each element used for the product (step S8).

The addition unit 15 acquires the value in the HIGH region of the mantissa of the addend and the LOW region highest-order number of the mantissa of the addend. Next, the addition unit 15 determines whether an increment or a decrement occurs in the HIGH region from, based on the LOW region highest-order number of the mantissa of the addend. Then, the addition unit 15 determines the value in the HIGH region from the determination result (step S9).

In addition, the addition unit 15 acquires an output value from the product bus 14. Here, the result of the product calculated by the FMA operation multiplication unit 12 and the product subtotal calculated by the DOT operation multiplication-addition unit 13 are collectively referred to as the output value from the product bus 14. Then, the addition unit 15 adds the output value from the product bus 14 and the mantissa of the addend to obtain two numbers. Thereafter, the addition unit 15 executes carry propagation addition on the two numbers representing the output values from the product bus 14 on the basis of whether or not it is the case A, further determines an addition result using the two numbers representing the output values from the product bus 14, based on whether or not it is the case A, and outputs the addition result (step S10).

The normalization/rounding unit 16 refers to the second digit of the mantissa of the addend, determines whether to perform carry or borrow in the HIGH region, and calculates the normalization shift amount (step S11).

Next, based on whether or not the addend is dominant, the normalization/rounding unit 16 calculates the addition result of the addend by using the addition result of the value in the HIGH region and the addend of the LOW region. Then, the normalization/rounding unit 16 executes a shift with the normalization shift amount on the addition result of the addend. In addition, the normalization/rounding unit 16 calculates the exponent and the sign by using the normalization shift amount, the temporary exponent, and the temporary sign. Then, the normalization/rounding unit 16 calculates the operation result by using the addition result, the exponent, and the sign of the shifted mantissa (step S12).

Thereafter, the normalization/rounding unit 16 executes rounding/exception processing according to the accuracy of the operation result (step S13). Then, the normalization/rounding unit 16 outputs the operation result (step S14).

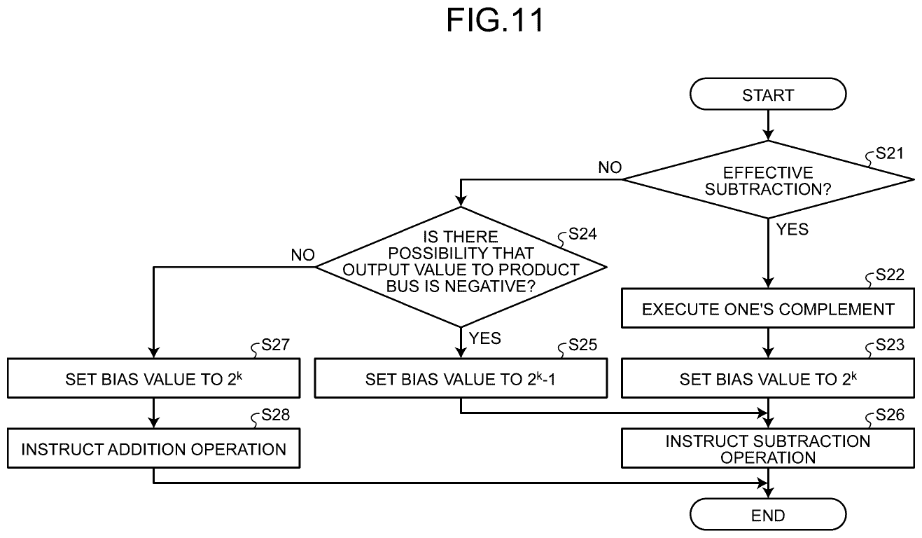

FIG. 11 is a flowchart illustrating details of the bias and operation determination processing. Next, a flow of the bias and operation determination processing by the arithmetic unit 1 according to the embodiment will be described with reference to FIG. 11.

The digit alignment unit 11 determines whether or not it is effective subtraction (step S21).

In the case of effective subtraction (step S21: Yes), the digit alignment unit 11 executes one's complement on the value in the LOW region of the mantissa of the addend (step S22).

Next, the DOT operation multiplication-addition unit 13 sets the bias value to 2\hat{ }k (step S23). Thereafter, the DOT operation multiplication-addition unit 13 instructs the addition unit 15 to perform a subtraction operation (step S26).

On the other hand, in a case where it is not effective subtraction (step S21: No), the DOT operation multiplication-addition unit 13 determines whether or not there is a possibility that the output value to the product bus 14 is negative, that is, whether or not it is the case B (step S24).

In a case where there is a possibility that the output value to the product bus 14 is negative (step S24: Yes), the DOT operation multiplication-addition unit 13 sets the bias value to 2\hat{ }k−1 (step S25). Thereafter, the DOT operation multiplication-addition unit 13 instructs the addition unit 15 to perform a subtraction operation (step S26).

On the other hand, in a case where there is no possibility that the output value to the product bus 14 is negative (step S24: No), in the DOT operation multiplication-addition unit 13, the DOT operation multiplication-addition unit 13 sets the bias value to 2\hat{ }k (step S27). Thereafter, the DOT operation multiplication-addition unit 13 instructs the addition unit 15 to perform an addition operation (step S28).

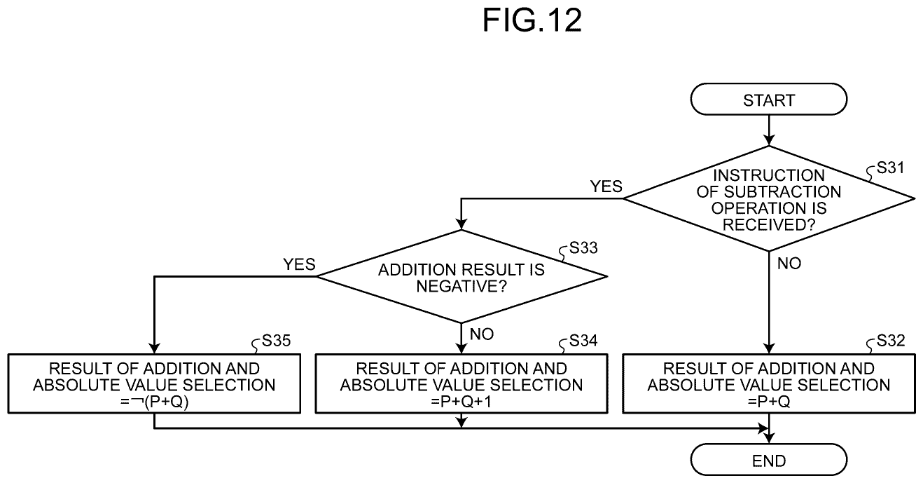

FIG. 12 is a flowchart of addition processing by the addition unit. Next, a flow of the addition processing by the addition unit 15 will be described with reference to FIG. 12.

The addition unit 15 determines whether or not an instruction of the subtraction operation has been received from the DOT operation multiplication-addition unit 13 (step S31).

In a case where the instruction of the subtraction operation has not been received (step S31: No), the addition unit 15 outputs P+Q as a result of addition of the value in the LOW region of the mantissa of the addend and the product subtotal and the selection of an absolute value for an addition result (step S32).

On the other hand, in a case where the instruction of the subtraction operation has been received (step S31: Yes), the addition unit 15 determines whether or not the addition result is negative (step S33).

In a case where the addition result is positive (step S33: No), the addition unit 15 outputs P+Q+1 as the result of the addition of the value in the LOW region of the mantissa of the addend and the product subtotal and the selection of the absolute value for the addition result (step S34).

On the other hand, in a case where the addition result is negative (step S33: Yes), the addition unit 15 outputs ¬(P+Q) as the result of the addition of the value in the LOW region of the mantissa of the addend and the product subtotal and the selection of the absolute value for the addition result (step S35).

### Specific Operation Example

Hereinafter, for example, the overall operation will be described by an example in which A1=+1.0, A2=−0.75, B1=+1.0, B2=+1.5, and C=+64 (=+1.0*2\hat{ }6), and A1*B1+A2*B2+C is calculated. An actual operation result is +63.875 (=+1.99609375*2\hat{ }+5 and 1.11111111 (with eight 1s following the decimal point) when the mantissa part is expressed in binary). Here, C and the operation result are expressed by IEEE754 single-precision, and A1, A2, B1, and B2 are expressed by IEEE754 half-precision.

When expressed by a sign, an exponent, and a mantissa of a floating point, in A1, sign=+ (represented as 0), exponent=0, and addend=1.0. In addition, in A2, sign=−(represented as 1), exponent=−1, and addend=1.5. In addition, in B1, sign=+ (represented as 0), exponent=0, and addend=1.0. In addition, in B2, sign=+ (represented as 0), exponent=0, and addend=1.5. In addition, in C, sign=+(represented as 0), exponent=+6, and addend=1.0.

Here, the LOW region has 60 digits, and the bias is defined as a value in which 1 is set at a digit that is one digit above the highest-order digit, that is, 2\hat{ }k (k=60). In addition, the HIGH region has 24 digits, and a digit having a weight of 32 in the mantissa of the product subtotal is defined as the lowest-order digit of the HIGH region. A weight of 16 is the weight of the highest-order digit in the LOW region.

The signs and exponents of A1, A2, B1, and B2 are input to the product subtotal tentative-sign/tentative-exponent calculation unit 131. Then, exponent of A1+exponent of B1=0 and exponent of A2+exponent of B2=−1, and since the former is larger, the product subtotal tentative-sign/tentative-exponent calculation unit 131 outputs exponent of A1+exponent of B1+constant=2 as the tentative exponent. In addition, the product subtotal tentative-sign/tentative-exponent calculation unit 131 outputs, as the tentative sign, 0 which is the exclusive OR of the sign of A1 and the sign of B1. Here, 0, which is the value of the tentative sign, represents +. This means that the product subtotal tentative-sign/tentative-exponent calculation unit 131 determines that the calculation result of (A1*B1)+(A2*B2) is likely to be affected since the exponent sum of A1*B1 is larger than that of A2*B2.

In addition, the exclusive OR of the sign of A1 and the sign of B1 is 0, and the exclusive OR of the sign of A2 and the sign of B2 is 1, which are different from each other. In addition, the absolute value of the difference between exponent of A1+exponent of B1 and exponent of A2+exponent of B2 is 1. In this regard, the product subtotal tentative-sign/tentative-exponent calculation unit 131 outputs the case B or D as the case determination result. This means that the product subtotal tentative-sign/tentative-exponent calculation unit 131 determines that (A1*B1)+(A2*B2) is effective subtraction, and the absolute values of (A1*B1) and (A2*B2) are close, so that it is uncertain whether (A1*B1)+(A2*B2) is positive or negative.

In the addition/subtraction determination unit 111 of the digit alignment unit 11, the circuit thereof outputs, as an addition/subtraction determination result (ESUB), 0 indicating effective addition since the tentative sign of the product subtotal is 0 and the sign of C is 0.

The product subtotal calculation unit 132 calculates mantissa of A1*mantissa of B1+mantissa of A2*mantissa of B2 (digit-aligned). In this case, the true operation result is −0.125, and the absolute value thereof is 0.00100 . . . (with all 0s thereafter) in binary number.

Then, the product subtotal calculation unit 132 sets the bias value to 2\hat{ }60−1 since the input addition/subtraction determination result is 0, indicating effective addition, the case determination result indicates that the case is the case B or D, and there is a possibility that the tentative sign is incorrect. This means the following. That is, in a case where addition is determined based on the tentative sign, but subtraction is actually performed, the carry propagation addition unit 155 of the addition unit 15 that performs processing later selects, as a positive operation result, a pattern that outputs P+Q+1 instead of P+Q so that a negative number can be calculated correctly. On the other hand, since the addition/subtraction determination result is effective addition on the mantissa side of C, subtraction from 2\hat{ }k−1 by one's complement is not performed by the low-order digit inversion unit 117 of the digit alignment unit 11, and there is no factor corresponding to the +1 part of P+Q+1. In this regard, instead of having a factor corresponding to the +1 part of P+Q+1, 1 is subtracted in advance from the bias of the value output to the product bus 14, so that consistency is obtained.

In this case, the product subtotal calculation unit 132 outputs, for the sum and carry of the product subtotal, a set of values that, when added, result in the number of 60 digits of 11111 11011 . . . (with all 1s thereafter). Here, a space after the fifth digit represents a position corresponding to the decimal point of the mantissa.

The addend dominance determination unit 113 has 2 as a determination value for the case A and the case B. Since the tentative exponent of the product subtotal is 2, the exponent of the addend is 6, and the exponent of the addend is larger by at least the determination value, the addend dominance determination unit 113 determines that the addend is dominant. In the addend, note that when it is not clear whether or not the addend is dominant, the addend dominance determination unit 113 refers to the number at the first decimal place of the mantissa of the addend, but the addend is obviously dominant in this operation example, so that the addend dominance determination unit 113 does not refer to the number at the first decimal place of the mantissa of the addend.

The temporary sign generation unit 112 sets the temporary sign to positive on the basis of the sign and the exponent of the input number. In addition, the temporary exponent generation unit 114 sets the temporary exponent to 28 on the basis of the sign and exponent of the input number. In addition, the digit alignment shift amount generation unit 115 sets the digit alignment shift amount to 22 on the basis of the sign and the exponent of the input number.

The mantissa digit alignment shift unit 116 performs a shift of 1.0 in the binary number which is the mantissa of the addend, such that the weight of the digit of the mantissa of the addend matches the weight of the digit of the mantissa of the product. In this case, since the second digit from the bottom of the HIGH region has a weight of 64, the mantissa of the addend is shifted so that the highest-order digit of the mantissa of the addend, which is 1, aligns with that that digit. Specifically, the mantissa digit alignment shift unit 116 shifts a mantissa input in left-alignment to the right by 22 digits according to the digit alignment shift amount. As a result, the mantissa digit alignment shift unit 116 outputs 00000000 00000000 00000010 as the value in the HIGH region and outputs all 0 as the value in the LOW region. In addition, as a result of the shift, the mantissa digit alignment shift unit 116 outputs 0 as the LOW region highest-order number of the mantissa of the LOW region.

Since effective addition is notified, the low-order digit inversion unit 117 does not perform inversion on the value in the LOW region of the mantissa of the addend, that is, one's complement, and outputs the input all 0s as they are.

In this example, the adder 154 adds three numbers: 0, which is the value in the LOW region of the mantissa of the addend, and two numbers, which correspond to carry and sum output from the product bus 14 and when added, result in 11111 11011 . . . (with all 1s thereafter). That is, the adder 154 outputs two numbers, P and Q, which, when added, result in 11111 11011 . . . (with all 1s thereafter). Since no overflow occurs in this operation example, the adder 154 does not notify of the overflow.

The carry propagation addition unit 155 outputs the positive addition result P+Q+1 and the negative addition result ¬(P+Q) since it is the effective addition and the case B or D. In this example, since P and Q are values that, when added, result in 11111 11011 . . . (with all 1s thereafter), the carry propagation addition unit 155 outputs 11111 11100 . . . (with all 0s thereafter) as the positive addition result (P+Q+1). In addition, the carry propagation addition unit 155 outputs 00000 00100 . . . (with all 0s thereafter) as the negative addition result (¬(P+Q)). In addition, since the overflow does not occur in the positive addition, the carry propagation addition unit 155 does not notify of the occurrence of the overflow.

Since it is the effective addition and the addend are dominant, the carry/borrow determination unit 153 determines the presence or absence of the carry/borrow, based on whether the number of overflows is one. Here, since the number of overflows is 0, the carry/borrow determination unit 153 notifies that carry or borrow occurs.

Since the addend is dominant and it is effective addition, the absolute value selection unit 156 outputs 11111 11100 . . . (with all 0s thereafter) which is a positive addition result. In addition, the absolute value selection unit 156 notifies that the sign has not been inverted.

Since the LOW region highest-order number of the mantissa of the addend is 0, the high-order digit INC/DEC unit 151 determines that the increment of the HIGH region, which is the carry from the LOW region to the HIGH region, does not occur. Then, the high-order digit INC/DEC unit 151 outputs the input 00000000 00000000 00000010 and 00000000 00000000 00000001, which is a value obtained by decrementing the input number by one.

Since it is effective addition and carry or borrow occurs, the high-order digit selection unit 152 selects and outputs the decremented value, that is, 00000000 00000000 00000001 among the input two numbers.

Since the addend is dominant, the high-order/low-order result selection unit 162 concatenates the upper half of the value in the LOW region to 00 . . . 00 0001, which is the value in the HIGH region. Then, the high-order/low-order result selection unit 162 outputs 00000000 00000000 00000001 11111 11100 . . . (with all 0s thereafter) which is a concatenated value.

The consecutive number prediction unit 161 outputs 6 or 7 as the prediction value of the number of consecutive 0s from the highest order and outputs 7 or 8 as the prediction value of the number of consecutive 1s from the highest order. At this level of detail, it is difficult to determine one of the values.

Since the addend is dominant and the first decimal number of the mantissa of the addend is 1, the normalization shift amount selection unit 163 outputs, as the normalization shift amount, a value obtained by adding a constant to the digit alignment shift amount. Here, the normalization shift amount selection unit 163 uses 0 as this constant. In this operation example, since the digit alignment shift amount is 22, the normalization shift amount selection unit 163 outputs 22 as the normalization shift amount.

The normalization shift unit 164 shifts the input value to the left by 22 digits according to the normalization shift amount of 22 to obtain 01 11111 11100 . . . (with all 0s thereafter). Furthermore, the normalization shift unit 164 performs a left shift of one-digit adjustment and outputs 1 11111 11100 . . . (with all 0s thereafter). This output represents the binary representation 1.11111111 (1.99609375 in decimal) of the mantissa part of the operation result. In addition, the normalization shift unit 164 notifies the result exponent calculation unit 165 that the adjustment of one-digit adjustment has been performed.

The result exponent calculation unit 165 receives the temporary exponent of 28, the normalization shift amount of 22, and a notification indicating that adjustment of one-digit adjustment has been performed, and outputs +5 as the exponent of the operation result.

Since the temporary sign is positive and there is no sign inversion, the result sign generation unit 166 outputs+as the sign of the operation result.

In this operation example, since an accurate operation result can be expressed by IEEE754 single-precision, the rounding/exception processing unit 167 determines that no rounding occurs. In addition, since both the input value and the operation result fall within a range that can be expressed by the IEEE754 single-precision and the half-precision normalization number, which are precisions on the premise, the rounding/exception processing unit 167 determines that no exception occurs.

As a result, the rounding/exception processing unit 167 can output accurate +63.875 (=+1.99609375*2\hat{ }+5) as the DOT operation result.

As described above, an arithmetic device according to the present embodiment allows outputting a negative number as the product subtotal, and classifies a case according to information, which is obtained from the number of elements of the product and the addend, on whether or not it is effective subtraction, and whether or not there is a possibility that the value output to the bus is negative. Then, the arithmetic device determines whether to add or subtract the bias value and the arithmetic operation actually executed for each case and outputs the operation result.

In addition, the arithmetic device according to the present embodiment determines whether an increment or a decrement occurs in the HIGH region, on the basis of the number at the highest-order digit in the LOW region. In addition, the arithmetic device according to the present embodiment determines whether the change in the number of digits is one digit loss or one digit gain, on the basis of the second digit from the top of the mantissa of the addend.

As a result, even when it is unclear whether the operation to be actually executed is effective addition or effective subtraction, arithmetic processing can be performed, and both the FMA operation and the DOT operation can be executed by one arithmetic unit by a small circuit change with respect to the FMA arithmetic unit. Therefore, it is possible to enhance an operation function while suppressing expansion of a circuit area. In addition, even when the sign (positive or negative) is not known, by using the bias, it is possible to output consecutive values to the product bus, and it is possible to smoothly execute the operation.

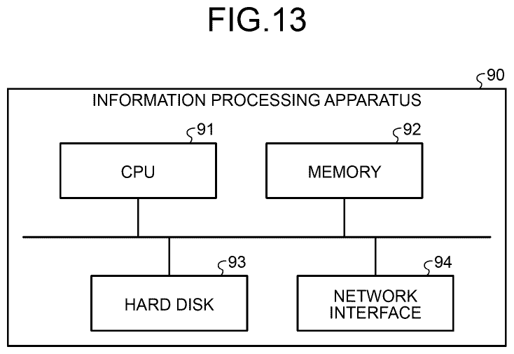

FIG. 13 is a hardware configuration diagram of an information processing apparatus on which the arithmetic unit according to the embodiment is mounted. For example, the information processing apparatus 90 includes a central processing unit (CPU) 91, a memory 92, a hard disk 93, and a network interface 94. The arithmetic unit 1 is mounted on the CPU 91. The CPU 91 is connected to the memory 92, the hard disk 93, and the network interface 94 via a bus.

The network interface 94 relays communication between the CPU 91 and an external device. The hard disk 93 is an auxiliary storage device, and stores various programs such as an operating system (OS) and an application.

The memory 92 is a main storage device, and is, for example, a random access memory (RAM).

The CPU 91 reads various programs stored in the hard disk 93, develops the programs in the memory 92, and executes the programs. When an FMA operation command or a DOT operation command is reached in execution of the program, the CPU 91 instructs the arithmetic unit 1 to perform an FMA operation or a DOT operation. Then, the CPU 91 acquires the operation result obtained by the arithmetic unit 1 and executes continuation of the program.

In one aspect, the present invention can enhance an operation function while suppressing an increase in a circuit area.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An arithmetic unit that executes a DOT operation of adding an addend to an addition result obtained by adding a plurality of products of two elements, the arithmetic unit comprising: a processor configured to:
first determine whether or not an operation of the addition result and the addend is effective subtraction or effective addition, on a basis of the elements and the addend, and perform digit alignment of the addend with respect to a subtotal of the products;
second determine whether or not there is a possibility that a value to be output becomes negative, on a basis of the elements, and calculate the product subtotal based on the addition result that becomes a negative or positive value, on a basis of a predetermined bias value and the elements; and
calculate an operation result by executing addition of the product subtotal calculated and the addend, on a basis of a determination result of the first determination and a determination result of the second determination.

2. The processor according to claim 1, wherein the processor is further configured to, in a case where a result obtained by adding the addend to the addition result is potentially a negative number, use, as the bias value, a value which allows a value obtained by adding the product subtotal and the addend to be positive, and correct the addition result on a basis of the bias value to obtain the product subtotal.

3. The processor according to claim 1, wherein
the processor is further configured to
calculate the product subtotal by adding the bias value to the addition result except a case where the result of the first determination is effective addition and there is no possibility that a value output from the result of the second determination is negative,
calculate the product subtotal by adding a value, which is obtained by subtracting 1 from the bias value, to the addition result in a case where the result of the first determination is effective addition and there is no possibility that the value output from the result of the second determination is negative,
execute addition in a case where the result of the first determination is effective addition and there is no possibility that the value output from the result of the second determination is negative, and
perform subtraction in a case where the result of the first determination is effective subtraction or there is possibility that the value output from the result of the second determination is negative.

4. The processor according to claim 1, wherein the processor is further configured to determine whether or not an increment or a decrement occurs in a value at a high-order digit, which is predetermined digits above a highest-order digit of the product subtotal, in the addend, based on a highest-order number of low-order digits, which are below the high-order digit, in the addend.

5. The processor according to claim 1, wherein the processor is further configured to, determine whether or not digit gain or digit loss occurs at a high-order digit, which is a predetermined digits above a highest-order digit of the product subtotal, in the operation result calculated, normalize the operation result, and perform rounding and exception processing to calculate a final DOT operation result.

6. The processor according to claim 1, wherein the processor is further configured to,
execute multiplication of two numbers among an FMA operation of multiplying the two numbers and adding an addend, and output a result of the multiplication to a product bus,
output the product subtotal to the product bus, and
acquire a result of the products or the product subtotal output from the product bus, and calculate an operation result by executing addition of the result of the products and the addend or addition of the product subtotal and the addend.

7. An arithmetic method comprising:
by a processor that executes a DOT operation of adding an addend to an addition result obtained by adding a plurality of products of two elements,
first determining whether or not an operation of the addition result and the addend is effective subtraction or effective addition, on a basis of the elements and the addend;
performing digit alignment of the addend with respect to a subtotal of the products;
second determining whether or not there is a possibility that a value to be output becomes negative, on a basis of the elements;
calculating the product subtotal based on the addition result that becomes a negative or positive value, on a basis of a predetermined bias value and the elements; and
calculate an operation result by executing addition of the product subtotal calculated and the addend, on a basis of a determination result of the first determination and a determination result of the second determination.
